(19) United States
(12) Patent Application Publication
(10) Pub. No.: US 2026/0330812 A1
(43) Pub. Date: Oct. 22, 2026

(54) SYSTEMS AND METHODS FOR DATASET GENERATION FOR IMPROVED DATA MODEL TRAINING AND INFERENCE

(71) Applicant: Borde, Inc., San Ramon, CA (US)

(72) Inventors: Saumitra Buragohain, San Ramon, CA (US); Akash Jyoti Borah, Assam, Pin (IN); Vineet Kiragi, Dublin, CA (US); Dipangshu Konwar, Guwahati (IN); Aiden Buragohain, San Ramon, CA (US)

(21) Appl. No.: 19/259,844

(22) Filed: Jul. 3, 2025

(30) Foreign Application Priority Data
Apr. 16, 2025 (IN) 202511036973

(51) Int. Cl. G06V 10/774; G06V 10/26; G06V 10/766; G06V 10/82; G06V 40/10

(52) U.S. Cl. CPC G06V 10/774; G06V 10/26; G06V 10/766; G06V 10/82; G06V 40/10

(57) ABSTRACT

In some aspects, the techniques described herein relate to systems and methods for object detection using one or more processors, including: a general object detection model configured to recognize categories of objects in a plurality of images; a set of specialized object detection models each configured to recognize sub-categories within a category; and an enhanced object detection model configured to recognize categories and sub-categories of the objects in the plurality of images. One or more processors can be instructed to: train the general object detection model; train each specialized object detection model; generate, using the set of specialized object detection models, a plurality of refined training images; train an enhanced object detection model to recognize the categories and sub-categories of the objects using the refined training images; and determine the categories and sub-categories of objects in a plurality of candidate images using the trained enhanced object detection model.

### RELATED APPLICATIONS

This application claims the benefit of Republic of India Patent Application No. 202511036973, filed on Apr. 16, 2025, and entitled “Systems and Methods for Dataset Generation for Improved Data Model Training and Inference”; which is hereby incorporated by reference for all purposes.

### BACKGROUND

Optical inspection systems can use one or more cameras to acquire, process and analyze images of objects to extract data from the objects in order to produce numerical or symbolic information. Optical inspection systems can be used in various applications including quality control (QC) or quality assurance (QA) to support a production (or manufacturing) process, and inspection and sorting of objects for recycling. In some cases, optical inspection systems can use artificial intelligence (AI), computer vision, and/or machine learning to analyze the acquired images.

Deep learning models for object detection and segmentation are used in industries such as food manufacturing, pharmaceuticals, and industrial automation. These models require large, annotated datasets to achieve high accuracy.

### SUMMARY

In some aspects, the techniques described herein relate to a method of object detection using one or more processors, including: providing a plurality of images; generating a set of synthetic training images including a set of objects by segmenting images of the plurality of images to produce a set of segmented foregrounds representing the set of objects, and combining the set of segmented foregrounds and a set of backgrounds; training a general object detection model to recognize a category of an object in an image using the set of synthetic training images; training a set of specialized object detection models, wherein each specialized object detection model is trained to recognize sub-categories of objects within a category recognizable by the general object detection model using a set of specialized training images, wherein the set of specialized training images includes less than 10% of the images included in the set of synthetic training images; generating, using the set of specialized object detection models, a plurality of refined training images by applying labels that associate an object in each image of the plurality of refined training images with a sub-category of the object; training an enhanced object detection model to recognize the categories and sub-categories of objects in the plurality of images using the generated plurality of refined training images; and determining the categories and sub-categories of objects in a plurality of candidate images using the trained enhanced object detection model.

In some aspects, the techniques described herein relate to a system for object detection, including: a general object detection model configured to recognize categories of objects in a plurality of images; a set of specialized object detection models each configured to recognize sub-categories within a category of the objects in the plurality of images, wherein each specialized model corresponds to a category recognized by the general object detection model; an enhanced object detection model configured to recognize categories and sub-categories of the objects in the plurality of images; and one or more processors and memory storing instructions that when executed by the one or more processors cause the one or more processors to perform operations including: training the general object detection model to recognize the categories of the objects using a set of training images; training each specialized object detection model of the set of specialized object detection models using a set of specialized training images, wherein the set of specialized training images includes objects labeled with sub-categories within a category and less than 10% of the images included in the set of training images; generating, using the set of specialized object detection models, a plurality of refined training images by applying labels that associate an object in each image of the plurality of refined training images with a sub-category of the object; training an enhanced object detection model to recognize the categories and sub-categories of the objects using the generated plurality of refined training images; and determining the categories and sub-categories of objects in a plurality of candidate images using the trained enhanced object detection model.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIGS. 1A and 1B show examples of segmentation for a real-world image of a fish.

FIG. 2 shows an example of synthetic image generation, where a real-world image of a fish has been segmented in a foreground that contains the object, and foregrounds of object have been combined with different backgrounds.

FIGS. 3A-3C show additional examples of synthetic images with foreground objects (fish) combined with different backgrounds.

FIGS. 3D and 3E show another example of segmentation for synthetic image generation with a foreground object that is an airplane.

FIGS. 3F and 3G show another example of segmentation for synthetic image generation with a foreground object that is a plastic bottle.

FIG. 3H shows an example of a 3D model of an object (an almond in this example) that was created using photogrammetry from images taken from many different angles.

FIG. 3I shows synthetic images of different objects (almonds in this example) from different angles.

FIG. 3J shows an example of real images of objects (almonds in this example) taken by an optical inspection system.

FIGS. 4A and 4B show examples of images with objects and their associated labels overlaid on the image.

FIG. 4C shows an example of an alternative approach to automatically generating a large set of training images using specialized models.

FIG. 5 shows an example flowchart of a computer-implemented method for training an object detection model to recognize the category and sub-category of objects in digital images.

FIGS. 6A and 6B are flowcharts of examples of computer-implemented methods for using a deep learning object detection model to categorize objects in images using one or more processors coupled to memory.

FIG. 6C is a flowchart of an example of a computer-implemented method for training a deep learning object detection model to categorize objects in images.

FIG. 7 shows a schematic of an example of an object detection system.

FIGS. 8A and 8B show examples of images including objects in different categories and sub-categories, which are portions of walnuts in FIG. 8A and fish in FIG. 8B.

FIGS. 9A and 9B show example flowcharts for categorizing objects in an image into sub-categories using an object detection model.

The illustrated embodiments are merely examples and are not intended to limit the disclosure. The schematics are drawn to illustrate features and concepts and are not necessarily drawn to scale.

### DETAILED DESCRIPTION

The present disclosure describes systems, models, and methods for artificial intelligence (AI) object detection. Methods for quickly training object detection models to achieve high accuracy using a small number of resources are described herein. Synthetic training data and models using few-shot learning techniques can be used to train an AI object detection model that has high accuracy and can run in a production environment. For example, a small number of manually labeled training images (e.g., less than 10 per category) can be used to train the AI object detection models described herein to achieve high accuracy (e.g., greater than 90%), with high speed (e.g., less than 100 ms or less than 35 ms to analyze an image), a high throughput (e.g., from 1000 to a million, or more than a million objects analyzed per second), and a level of computation complexity commensurate with a manufacturing environment.

Conventional deep learning models for object detection and segmentation are used in industries such as food manufacturing, pharmaceuticals, and industrial automation. These conventional models require large, annotated datasets to achieve high accuracy. However, the generation of such datasets using conventional approaches is resource-intensive, time-consuming, and prone to errors, particularly in scenarios with complex objects or a large number of object categories. Conventional deep learning models, such as Convolutional Neural Networks (CNNs), rely heavily on human-annotated datasets. This creates bottlenecks in the model development lifecycle, particularly during the labeling phase, where human error and resource constraints can lead to delays in delivering AI object detection models for production use. Moreover, data imbalance issues, especially in detecting rare defects or objects, often result in suboptimal model performance, particularly in critical applications such as allergen detection or quality assurance in manufacturing.

The object detection models and training methods described herein provide a robust and scalable solution for enhancing the accuracy of AI models in object detection and segmentation. By combining synthetic data generation and few-shot learning, the time and costs associated with human labeling can be drastically reduced, and high-accuracy models can be efficiently implemented in real-time production environments.

The object detection models and training methods described herein can be used to enable fast and accurate AI object detection with high throughput for virtually any type of object. For example, industries such as manufacturing, pharmaceuticals, food processing, and industrial automation, where high accuracy and rapid deployment are critical can benefit from the object detection models and training methods described herein. Additionally, air traffic control systems, autonomous vehicle vision systems, recycling and waste sorting systems, medical imaging, and automated video security systems can benefit from the object detection models and training methods described herein.

The systems, models, and methods described herein relate to the development and improvement of AI object detection models and neural network-based object detection models using advanced data generation techniques. In some cases, the method leverages synthetic data generation (e.g., using segmentation of real-world images, or model-generated images) and specialized models (e.g., using few-shot learning techniques and/or rule-based algorithms) to generate data sets of training images, which can then be used to train an enhanced object detection model that has high accuracy. The synthetic data generation and specialized models can be used to generate refined training images with labels that include categories and sub-categories of objects. These automatically labeled refined training images obviate the need for a large dataset of manually labeled images and can be used to train the enhanced object detection model to achieve high accuracy (e.g., greater than 90%).

Deep learning object detection or neural network-based object detection is a computer vision technique that uses neural networks, for example convolutional neural networks (CNNs), to identify and locate objects within an image or a video frame. The primary goal of object detection is to determine the presence of specific objects in an image and, if present, specify their locations with bounding boxes. It therefore involves both classification (identifying the object category) and regression (predicting the object's position).

Deep learning object segmentation, also known as instance segmentation, is a computer vision task that involves identifying and delineating the precise boundaries of individual objects within a starting image. Unlike object detection, which uses bounding boxes, object segmentation provides pixel-level masks for each object in the image, which can enable a more detailed understanding of the object's shape and position within the scene of the image. For example, it can be useful in scenarios where multiple objects of the same category overlap in an image. One type of model that can be used for segmentation in the systems and methods described herein is a Segment Anything Model (SAM), which is an AI model that can "cut out" any object, in any image, with a single command. SAM is a promptable segmentation system with zero-shot generalization to unfamiliar objects and images, without the need for additional training.

In some cases, one or more of the general object detection models, the specialized models (e.g., used to determine sub-categories of objects), and the enhanced object detection models described herein can include rule-based models. Rule-based detection is a technique used in object detection models to identify and classify objects based on predefined rules or constraints. These rules can be derived from domain knowledge, or empirical observations about the characteristics of the objects being detected. In some rule-based systems, these rules are hardcoded into the system using logical operators (e.g., AND, OR, NOT) and conditional statements to evaluate object features such as shape, color, size, texture, etc. For example, a rule can be utilized that states - if an object is found to be red and has a circular shape, then it can be categorized as a tomato. In another example, a rule could state - if an object is green and has a rectangular shape with sharp edges, then it can be categorized as a leaf.

In one or more of the general object detection models, the specialized models, and the enhanced object detection models described herein, rule-based detection can be used in a variety of ways. For example, rule-based detection techniques can be used to filter out irrelevant objects by applying rules that eliminate objects based on features such as size, color, or orientation. This can be beneficial to reduce the number of false positives and focus on more relevant object detections. Rule-based techniques can also be used to refine classification results, where they can provide additional context to neural network-based object detection models by providing a set of possible categories for an object, which can then be further refined using machine learning algorithms.

Additionally, rule-based detection can be used in one or more of the general object detection models, the specialized models, and the enhanced object detection models described herein, either solely using rule-based techniques, or in combination with AI or deep learning object detection models. For example, rule-based techniques can be used for color-based filtering, where rules based on color histograms or color spaces (e.g., HSV) are used to filter out objects that do not match a specific color profile. In another example, rule-based techniques can be used for shape-based classification, where one or more shape-related rules using geometric features such as aspect ratio, convex hull, or contour properties are used to categorize objects. An example of integrating rule-based techniques and neural network-based object detection models, includes using one or more rule-based systems as pre-processing step(s), where rules are applied before feeding data into a neural network-based object detector to reduce the number of false positives or irrelevant objects. In some cases, rule-based techniques can be integrated into machine learning algorithms, where rule-based systems are used to provide additional context and refine classification results from neural network-based object detection models. In some cases, by combining the strengths of both rule-based and neural network-based object detection approaches, the specialized models described herein can be created and trained to be more robust and accurate than conventional machine object or feature detection approaches.

A general object detection model that is a neural network-based object detection model can be trained from no knowledge to about 80% accuracy using training images that are conventionally labeled by a human. Human labeling training data is slow, expensive, and prone to errors. For example, errors can occur when a human draws bounding boxes around objects detected, which can cause issues regarding sizing the object or missing objects. Errors can also occur regarding proper classification of objects especially when there are many classes (e.g., 40-50 classes) to be labeled in training images for an AI object detection model. AI object detection models require deep quality specific domains to be labeled in training images in order to achieve high accuracy, and therefore, a highly-skilled human (e.g., trained for 3 or more years) can be required to label objects in the training images.

Defective products (e.g., those that can cause recalls) can be difficult to detect. For example, allergens like almonds in macadamia nuts that are not caught by X-Ray imaging or other detection techniques. One technical problem with detecting these types of defects is that such defects can occur in such low volume that there is not enough training data to train an AI model effectively. This causes data imbalance issues with the AI model.

The present systems and methods provide a technical solution to the technical problem by generating and/or utilizing synthetic data to create tens to hundreds of thousands of images very quickly (e.g., in less than 24 hours, or less than 12 hours, or less than 1 hour), which provides a technical effect of reducing a number of object detection model training cycles from 1 year (or longer) to 1 week.

For example, an object detection model can be created to recognize categories of fish in front of different backgrounds. A dataset of starting images of fish of different classes (e.g., 20 different classes) are obtained. These starting images can be taken using image capture devices (camera, or video camera), or can be downloaded from a database of images (e.g., a publicly available dataset from Kaggle.com, or the like). Each starting image in the dataset can be segmented to define one or more objects (i.e., in the foreground) from a background in each image. Synthetic data can be created by fusing the segmented object in the foregrounds with backgrounds (e.g., water, a tabletop, a conveyor belt) to get synthetic training images with labels associated with the class(es) of object(s) in the image. These synthetic training images can then be used to train an object detection model to recognize the classes of fish in the images, for example, by generalizing and determining the different fish features to differentiate among the classes. For example, the object detection model can be one or more of: a deep learning object detection model, a convolutional neural network, a region-based convolutional neural network (R-CNN), a Fast R-CNN, a Faster R-CNN, and a regression-based object detection model. In some cases, an object detection model can achieve about 80% mean average precision (mAP) using such synthetic training images. When testing a deep learning object detection model, each category can be given an accuracy score, and the mAP represents a measure of the average of the scores over all of the categories. In some cases, the object detection models described herein can include one or more of: vision transformer-based models, agentic object detection models (e.g., VisionAgent from LandingAI), that use reasoning-driven AI, agentic patterns, and intrinsic attribute recognition. Some agentic object detection models can utilize zero-shot object detection, where they are able to detect objects without needing to be trained on labeled data for those specific objects.

In some cases, the object detection models described herein can include CNNs to detect objects within images. A CNN can be used to process an image through a series of convolutional layers that apply filters to small regions or patches of the input image. Each filter can be used to detect specific features, such as edges, lines, or patterns. The output from the convolutional layers can then be passed through one or more activation functions to enhance feature extraction, for example using functions that introduce non-linearity, functions that utilize Rectified Linear Unit (ReLU) analysis, or the like. Subsequent pooling layers and flattening steps can be used to form dense connections that allow the network to learn complex patterns and relationships between features. The model can then be used to produce class probabilities or bounding box coordinates based on detected objects in an output layer.

In some cases, the object detection models described herein can include vision transformer-based object detection models for digital images that include a transformer encoder to process image features, followed by an agentic model as a layer on top. The transformer encoder can use self-attention mechanisms to capture long-range dependencies and contextual relationships within input image data, allowing it to detect complex patterns in the image. These types of models can be useful when analyzing images with objects of varying sizes and shapes, or those that are partially occluded or cluttered. The agentic model can then take the transformed feature representation as input and can be used to predict class or category probabilities and bounding box coordinates for each detected object. In some cases, transformer-based models can use from about 10 billion to about 100 billion parameters to analyze an image, while typical CNNs use from about 10 million to about 100 million parameters. Due to their complexity, transformer-based models are typically robust to varying image conditions.

The techniques described herein relate to AI object or feature detection systems, models, and methods, such as the generation of training data to train the models.

A technical problem that may occur with a deep learning approach is the labeling cost of the training data used to train the models to recognize certain categories of objects. The objects in the training images are typically annotated such that an object in the image is related to a classification (e.g., a category or sub-category). In some cases, a feature of the object is analyzed and used to determine the category or sub-category of the object. Each image can take 5 minutes to annotate by a human, and therefore it would take 694 person days (working 24x7x365) or 8 years working 40 hours per week to annotate 200,000 images used to train a deep learning model. This is a high cost for training high-accuracy models on new types of object classifications (e.g., food products, manufacturing, pharmaceutical products) because human-based annotation of training images is the bottleneck.

The systems, models, and methods described herein provide a technical solution to the above technical problem by leveraging synthetic data generation and specialized models to ensure reduced annotation time of training images and reduced human error, each of which may improve the accuracy of the final enhanced object detection model while reducing reliance on manual labeling. Additionally, the enhanced object detection model can be accurate and also can be chosen to minimize computational complexity, which is also beneficial for use in production (e.g., manufacturing) environments. The specialized models may utilize a high degree of computation complexity to generate the refined training images by labeling the refined training images with categories and sub-categories.

In some cases, there is one specialized model for each category of objects, and each specialized model can be trained to recognize sub-categories of objects within a category. Each specialized model can use a small number (e.g., less than 20, less than 10, or less than 5) training images to train the models to recognize the sub-categories of the objects with high accuracy. In some cases, a specialized object detection model can be trained using a set of training images that has less than 10% of the images of a set of images used to train a general object detection model. Once the specialized model is trained, then it can be used to generate refined training image within the category, where each object shown in each refined training image is labeled with a sub-category. The specialized models can be used in parallel to generate refined training image for all categories of objects, where each object shown in each refined training image is labeled with a sub-category.

For example, a manufacturing line can include a stream of products, such as food products, building materials, toys, etc. The products can include several categories, such as category A, B, C, D and E (e.g., types of fish including salmon, trout, bass, etc.). Each category can further include sub-categories, such as sub-category A1, A2, A3, etc., which can correspond to the color of salmon, or the variety of salmon. In another example, the category could be type of nut (e.g., almond, pistachio, walnut, etc.) and the sub-category can include different types of defects (e.g., broken, discolored, etc.) or size of nut for each category.

In some cases, an initial general object detection model can be trained to recognize the categories of objects within a set of training images. These initial training images can be real-world images that are labeled manually, or can be generated using synthetic data generation techniques.

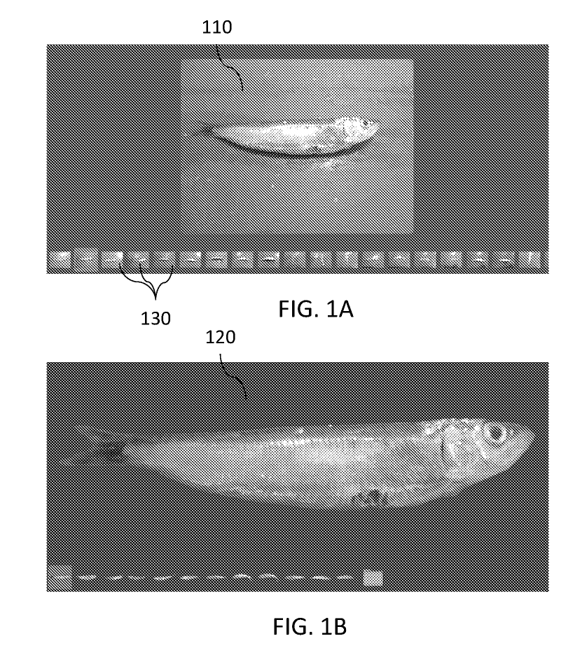

FIGS. 1A and 1B show examples of segmentation for real-world images of fish (these images are from “A Large-Scale Dataset for Segmentation and Classification,” by O. Ulucan, D. Karakaya, M. Turkan as described in https://ieeexplore.ieee.org/abstract/document/9259867). Image 110 in FIG. 1A was selected from a database 130 of real-world images of fish found at https://www.kaggle.com/datasets/crowww/a-large-scale-fish-dataset, licensed under https://creativecommons.org/licenses/by/4.0/. Image 120 in FIG. 1B has been segmented such that the foreground containing the object, the fish in this example, has been segmented from the background.

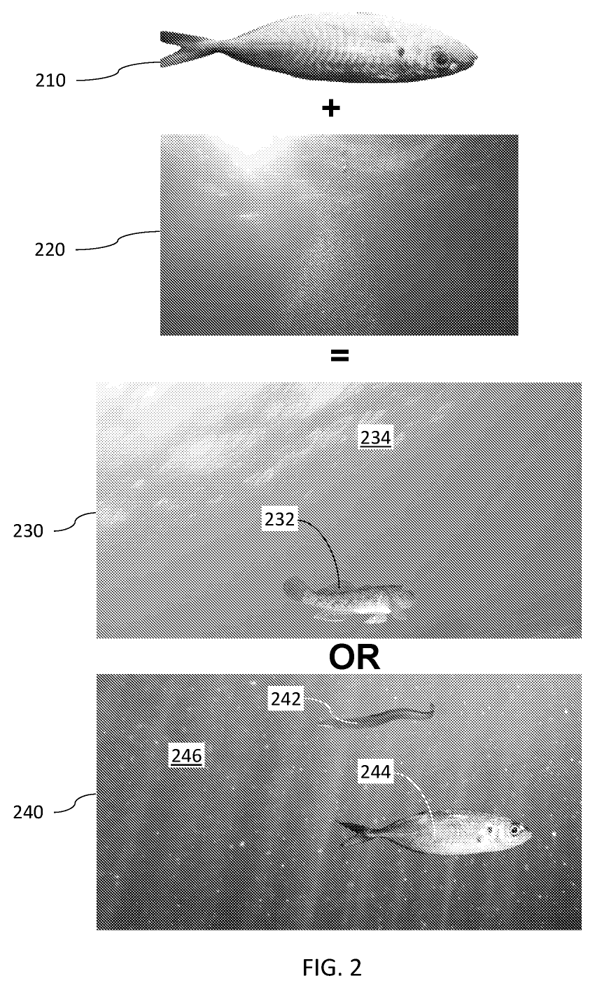

FIG. 2 shows an example of synthetic image generation, where a starting image (a real-world image in this case) of a fish has been segmented in a foreground that contains the object, and foregrounds of objects have been combined with different backgrounds. For example, the foreground can be partially or substantially overlayed on top of the pixels of the background, or the pixels in the foreground can be partially or substantially merged with pixels from the background. In this example, a real-world image of a fish has been segmented into a foreground 210 that contains the object (i.e. the fish). The segmented foregrounds can then be combined with a background 220, to produce a synthetic image 230, 240. Synthetic image 230 contains foreground object 232 and background 234. Synthetic image 240 contains foreground objects 242 and 244 and background 246. A set of foreground images and a set of backgrounds can be (randomly) combined to generate a larger set of synthetic training images where the foregrounds are placed in different locations in the training images and are combined with different backgrounds.

In some cases, one or more object detection models are used to generate the synthetic images by segmenting the foregrounds from the starting images, associating a category with an object in the segmented foreground, and combining the categorized foreground images with backgrounds to generate labeled synthetic training images. The one or more object detection models (e.g., a deep learning model, a vision transformer-based model, and/or a rule-base model) can recognize a category of an object in the starting image and identify the location of the object, for example by identifying coordinates of a bounding box for the object. The foreground image including the object can be segmented from the background of the starting image, for example using a Mask R-CNN or an SAM model. A label with the category of the object recognized by the object detection model(s) can be associated with the segmented foreground image of the object. Synthetic images including objects that are labeled with their associated categories can then be generated using the labeled foreground images of the objects in combination with one or more backgrounds. In some cases, the starting image(s) can include objects from more than one category. In such cases, the one or more object detection models can identify the categories of objects from different categories within a starting image, segment foreground images, where each foreground image includes an image of one of the objects, and label each foreground image with an associated category. The one or more object detection models described above can include any of the object detection models described herein, such as one or more of a deep learning object detection model, a convolutional neural network, a region-based convolutional neural network (R-CNN), a Fast R-CNN, a Faster R-CNN, a regression-based object detection model, one or more rule-based models, or a combinations of deep learning and rule-based models. In some cases, the one or more object detection models can include one or more of a vision transformer-based model and an agentic object detection model that uses reasoning-driven AI, agentic patterns, and intrinsic attribute recognition.

In some cases, two models can be used to generate synthetic images, where a segmentation model (e.g., a deep learning, a vision transformer-based, a Mask R-CNN, an SAM, or a You Only Look Once (YOLO) segmentation model) is used to segment foreground images of objects from a background in a starting image, and a recognition model (e.g., a deep learning, a vision transformer-based, R-CNN, or YOLO model) is used to recognize categories of the objects within the starting image. Coordinates of bounding boxes for the object foregrounds segmented by the segmentation model can be compared to coordinates of bounding boxes for the objects recognized by the recognition model, and if the bounding boxes overlap significantly then they can be associated with one another. The foreground images can be labeled with the categories of the objects therein and subsequently used to generate labeled synthetic training images. For example, an algorithm can be used to determine an intersection over union (IoU) value between bounding boxes identified using the segmentation model and the recognition model, and the IoU value can be used to determine whether to associate two bounding boxes with one another. High IoU values (e.g., those greater than 0, or greater than 0.5) indicate that a bounding box has a high degree of overlap with another bounding box, which indicates a high likelihood that the bounding boxes are surrounding the same object. Advantages of this IoU-based approach is that no image processing is required and a relatively simple algorithm for determining an IoU can yield accurate results. The segmentation and recognition models described above can include any of the segmentation and object detection models described herein, such as one or more of SAM, a deep learning object detection model, a convolutional neural network, a region-based convolutional neural network (R-CNN), a Fast R-CNN, a Faster R-CNN, a regression-based object detection model, one or more rule-based models, or a combinations of deep learning and rule-based models. In some cases, the segmentation and recognition models can include one or more of a vision transformer-based model and an agentic object detection model that uses reasoning-driven AI, agentic patterns, and intrinsic attribute recognition.

When generating the synthetic images, variation between images can be achieved in various ways including one or more of: rotating the foreground images, increasing or decreasing the size of the foreground images, changing the number of pixels in the foreground images, changing the number foreground images per image, changing the respective location(s) of object(s) in foreground images within the image, and changing the amount of occlusion between objects in foreground images. When generating the synthetic images, the foreground images can be rotated at different angles within the same synthetic image and in different synthetic images. For example, two or more foreground images can be combined with a background image and the foreground images can be rotated at different angles within the same synthetic image. When generating the synthetic images, the number of pixels or the size of the foreground images can be changed within the same synthetic image and in different synthetic images. For example, two or more foreground images can be combined with a background image and the number of pixels or the size of the foreground images can be changed within the same synthetic image. When generating the synthetic images, the respective locations of the foreground images can changed within the same synthetic image and in different synthetic images. For example, the respective locations of objects in foreground images can be varied between different synthetic images. In another example, several foreground images can be combined with a background image and the respective locations of the foreground images can be changed with respect to one another within the same synthetic image. When generating the synthetic images, the amount of occlusion between foreground images can be changed within the same synthetic image and in different synthetic images. For example, two or more foreground images can be combined with a background image and the amount of occlusion between the foreground images can be changed within the same synthetic image.

In some cases, synthetic images can be generated by combining a set of segmented foregrounds and a set of backgrounds using an algorithm. An algorithm can also be used to vary the position and orientation of the segmented foregrounds, and/or to combine the segmented foregrounds with a background of the set of backgrounds. For example, the algorithm could randomize which foregrounds are combined with which backgrounds.

When generating the synthetic images, variation between images can be achieved using one or more algorithms to vary attributes of the synthetic images, where the attributes include one or more of: rotation of the foreground images, the size of the foreground images, the number of pixels in the foreground images, the number of objects in foreground images per image, the respective location(s) of object(s) in foreground images within the image, the amount of occlusion between objects in foreground images), the background image, and the attributes of the background image (e.g., one or more of: background color, background tone or hue, background picture, background lighting gradient, and background pattern). In some cases, the algorithm(s) can randomize or approximately randomize the attributes of the images. In some cases, the algorithm(s) can simulate real-world conditions by varying the attributes of the synthetic images to mimic situations observed in real-world situations. For example, the sizes of the objects in the synthetic images can be generated using the algorithm(s) to match an observed (e.g., measured) distribution of sizes of objects of interest. Additionally, the algorithm(s) can select foreground images from a group of foreground images to match a particular real-world condition. For example, the algorithm(s) can select foreground images from a group of foreground images to match an observed lighting condition of a real-world situation. The algorithm(s) can also vary the background images that are combined with the foreground images in the synthetic images. The algorithm can be provided with a set of background images, and the algorithm can select a background image, and optionally vary an attribute of the background image, to be combined with one or more foreground images to generate the synthetic image. For example, the algorithm(s) can vary the background or an attribute of a background image to match an observed color, lighting, tone or hue, picture, lighting, and background pattern. The algorithm(s) used to generate the synthetic images can introduce variation into the generated synthetic images that can be advantageous to train the deep learning object detection models as described herein.

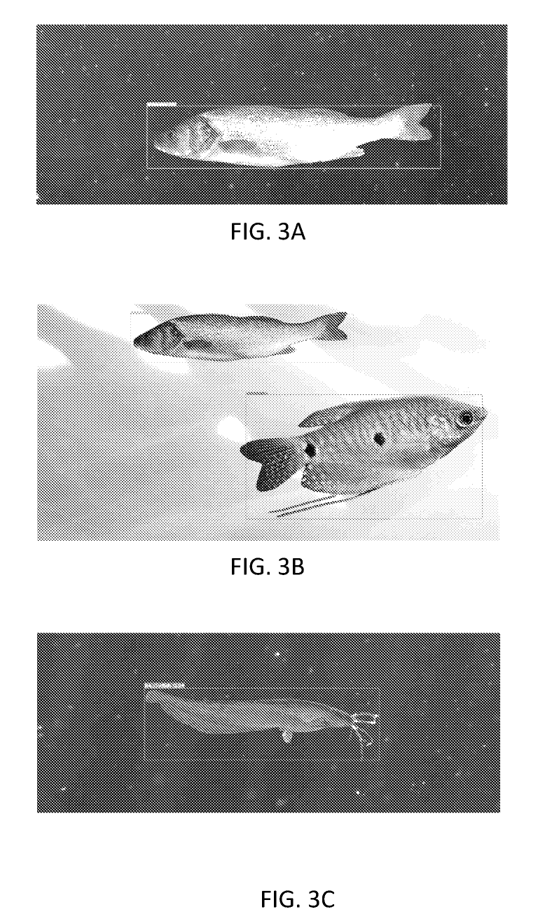

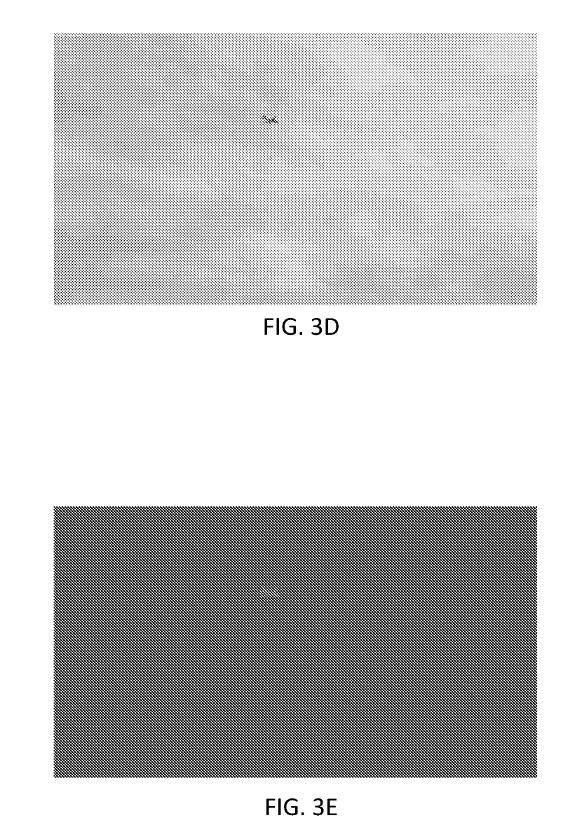

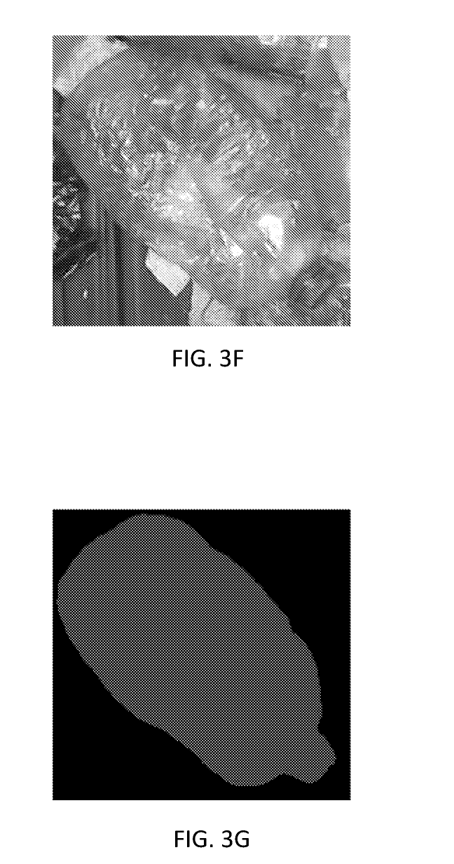

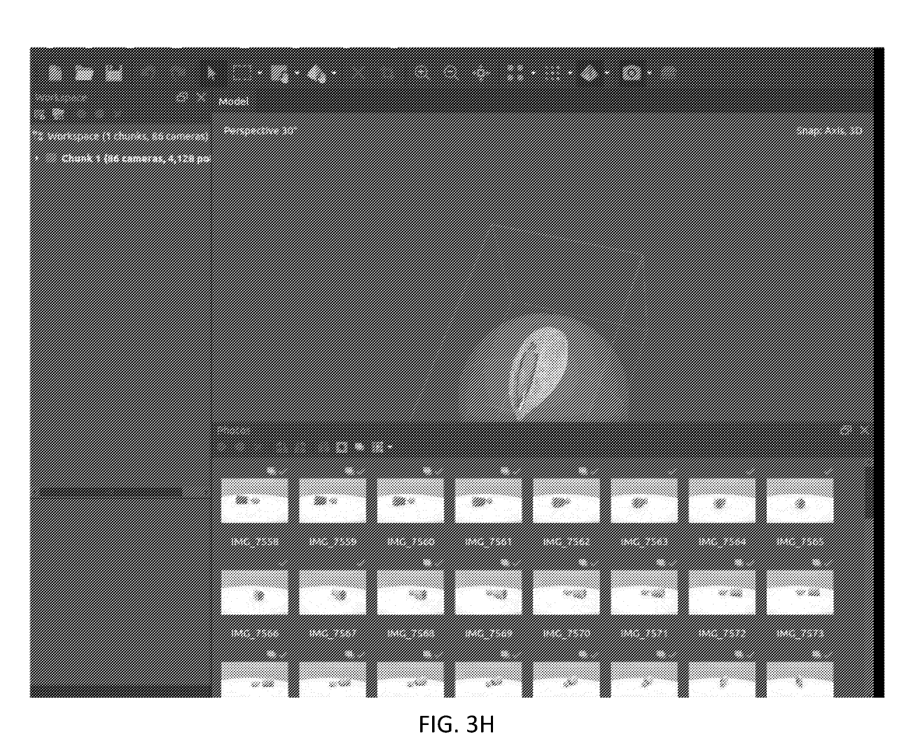

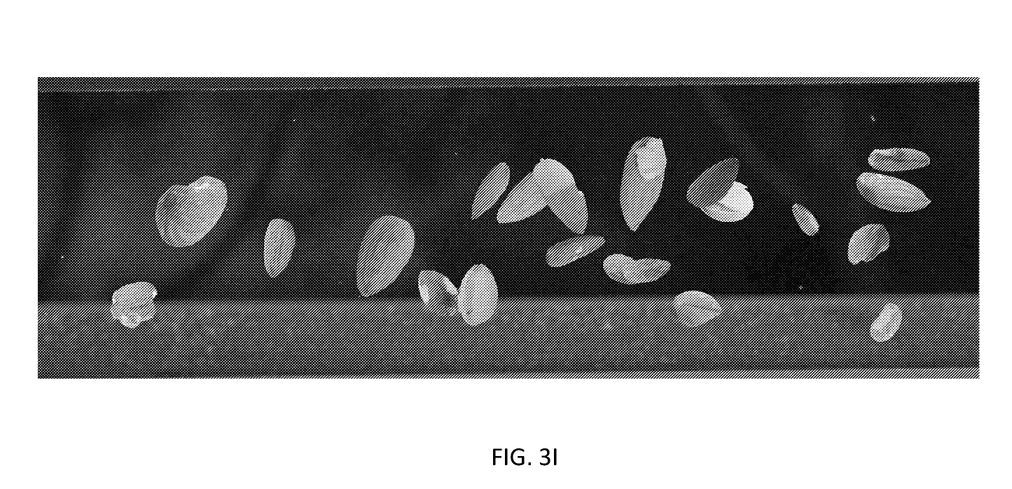

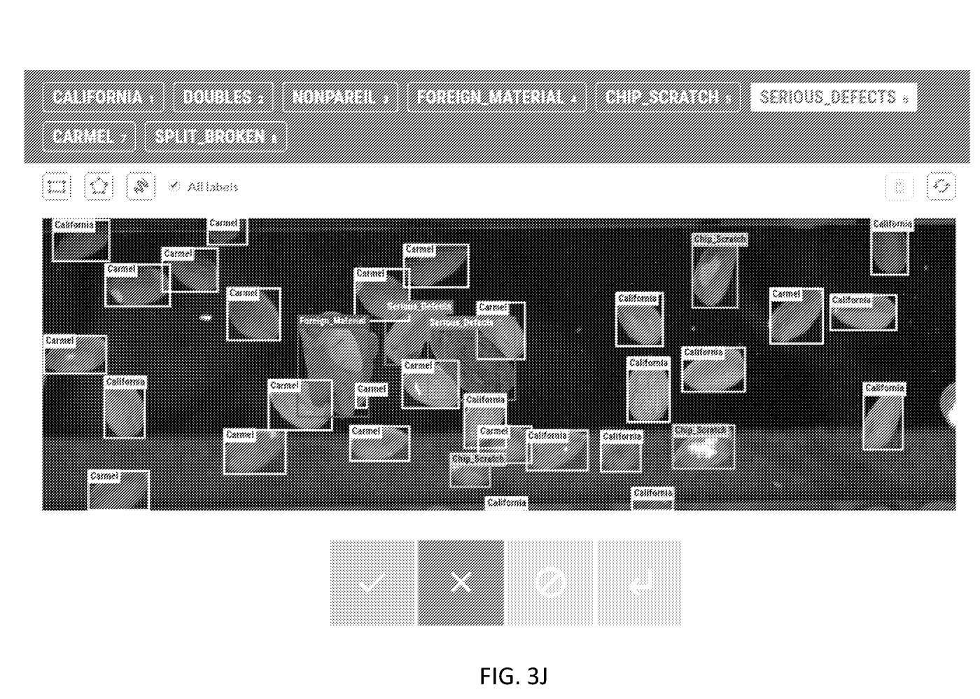

FIGS. 3A-3C show additional examples of synthetic images with foreground objects (fish) combined with different backgrounds. These synthetically generated training images were labeled using the labels from the real-world images that were segmented to produce the foregrounds. This can be beneficial since it can take a smaller set of labeled images and produce a variety of labeled training images which can be used to train an AI object detection model. Additionally, synthetic data generation can also address data imbalance issues, such as providing a model with sufficient data to be trained to detect a rarely occurring sub-category (e.g., a rare variety of object, or a rare defect type).

FIGS. 3D and 3E show another example of segmentation for synthetic image generation with a foreground object that is an airplane. FIG. 3D shows a starting real-world image of an airplane with a sky background. FIG. 3E shows a mask that has been produced using segmentation techniques (this example is from “Accurate plane shapes/segmentation,” by MetaVision available at https://www.kaggle.com/datasets/metavision/accurate-plane-shapessegmentation/data, licensed under https://creativecommons.org/licenses/by/4.0/). The mask can be used to remove the foreground with the object, a plane in this case, so that it can be used to generate synthetic images by combining the plane foreground with different backgrounds (e.g., different sky colors and lighting conditions).

FIGS. 3F and 3G show another example of segmentation for synthetic image generation with a foreground object that is a plastic bottle. FIG. 3F shows a starting real-world image of a plastic bottle with a background of other objects (e.g., at a recycling facility, or in a garbage can, available at https://www.kaggle.com/datasets/parohod/warp-waste-recycling-plant-dataset). FIG. 3G shows a mask that has been produced using segmentation techniques. The mask can be used to remove the foreground with the object, a plastic bottle in this case, so that it can be used to generate synthetic images by combining the plastic bottle foreground with different backgrounds. Synthetic images can also be created where the plastic bottle is partially occluded or partially depicted, which can be beneficial since object detection models trained on images including occluded or partially depicted objects can improve their accuracy for detecting objects that are occluded or partially depicted when the object detection model is used in an inference mode (e.g., to detect objects in images during actual use, not training or validation).

Any of the models described herein including the general object detection models, the specialized object detection models, and the enhanced object detection models can be trained using synthetic data. The synthetic data can be generated using real-world datasets, images, and/or CAD models. The synthetic images can be created by fusing object foregrounds segmented from real-world images or from images produced using image generation models with various backgrounds (e.g., randomized or algorithmically selected combinations of foregrounds and backgrounds) to include a diverse dataset that can be produced rapidly at scale. A label is associated with each object in the synthetic images, where the label denotes a category or a sub-category of the object. The category or sub-category is known from the originally labeled image from which the object foreground is segmented to generate the synthetic image. In some cases, the original labels are manually created. For example, an initial general object detection model can be trained using the automatically labeled synthetic images and the accuracy can achieve about 80% without the need for manual annotation. In some cases, the labels in the original images (e.g., the real-world or model-generated images) are created using an object detection model or set of models to further reduce the amount of manual labeling required.

Few-shot learning and/or rule-based specialized models can be trained to detect categories and sub-categories of objects using a small number of training images (e.g., less than 20, less than 10, or less than 5). The specialized models can be trained on a minimal number of labeled examples to recognize sub-categories of defects or object categories. In some cases, a specialized object detection model can be trained using a set of training images that has less than 1%, less than 5%, less than 10%, or less than 20% of the number of images in a set used to train a general object detection model. The few-shot learning models can then be used to generate additional training images by detecting the categories and sub-categories of the objects in the images (e.g., real-world or synthetically produced images) and automatically adding the appropriate label to each object in the image. The refined training data generated using the specialized models can then be used to train a general object detection model (e.g., a smaller faster production-ready model) with high accuracy (e.g., greater than 90%). The models and methods described herein are advantageous since they can significantly reduce the time required to reach high accuracy while ensuring the final model is usable or optimized for real-time deployment.

In some cases, a two-phase approach can be used. In the first phase, synthetic data generation is used to train a general object detection model. In a second phase, specialized models using rule-based or few-shot learning techniques are used to further refine the training images, which are used to train an enhanced model to achieve performance beyond the initial general object detection model. In some cases, the general object detection model in the first phase is used to analyze images and the results of the analysis are used to determine which types of specialized models are used in the second phase. In some cases, the results of the analysis in the first phase are used to determine which types of training images each set of specialized models use in the second phase. In some cases, the general object detection model in the first phase is used to determine which types of training images each set of specialized models use in the second phase. This approach can support the creation of faster, smaller AI object detection models better optimized for real-time production environments.

For example, in the first phase, the general object detection model can be used to determine which categories of object are present in an initial data set of images. A set of specialized models can be chosen for the second phase, where a specialized model is chosen to correspond to each category determined in the first phase. A human can label a set of images from each category determined in the first phase (e.g., less than 20, or less than 10, or less than 5 images) with a sub-category label. In some cases, a specialized object detection model can be trained using a set of training images that has less than 1% or less than 10% of the images in a set of images used to train a general object detection model. These specialized training images can then be used by the specialized models in the second phase.

The object detection models and training methods described herein can enhance the accuracy of AI models used in object detection and segmentation using specialized models and synthetic image generation. The result is a final production model that has both high accuracy (e.g., greater than 90%) and a reduced time and costs associated with training compared to conventional approaches.

Optical inspection systems and methods for inspection of moving objects, free falling objects, and/or fast-moving objects ("fast-moving object") can utilize the enhanced object detection models described herein. Therefore, optical inspection systems and methods for inspection of moving objects can also benefit from the systems, models, and methods described herein for providing the enhanced object detection models described herein.

The moving object (e.g., fast-moving objects) can move faster than about 1 m/s, from about 1 m/s to about 10 m/s, r from about 2 m/s to about 6 m/s, or from about 0.1 m/s to about 10 m/s. The optical inspection systems using the enhanced object detection models described herein enable inspection of a high number of objects (e.g., fast-moving objects) per time interval. For example, the optical inspection systems described herein enable inspection of an object in less than about 18 ms to about 20 ms, or about 10 objects in less than about 18 ms to about 20 ms, or up to about 100 objects in less than a time period from about 18 ms to about 20 ms, or up to about 40,000 lbs of objects per about one hour, or about 20 metric tons of objects per about one hour, or about 5000 objects per about one second. In some cases, the optical inspection systems enable inspection of an object in less than about 20 ms, less than about 35 ms, or less than about 100 ms. In some cases, the optical inspection systems described herein enable inspection of from about 10 to about a million objects per second, with the inspection of each object taking less than about 20 ms to about 100 ms. The optical inspection systems can be applied in a variety of applications including, but not limited to, identifying and/or sorting of food (e.g., nuts), waste and/or recyclable objects, mining and minerals, and pharmaceutical and nutraceutical products, manufacturing, industrial automation, air traffic control systems, autonomous vehicle vision systems, and automated video security systems.

In some cases, the optical inspection systems using the enhanced object detection models described herein can also perform sorting of objects, for example, by using a mechanism (e.g., an ejector or a robotic arm) to route objects to different locations based on the results (e.g., classification, or grades) output from a component of the optical inspection system.

The optical inspection systems and methods using the enhanced object detection models described herein can acquire images of (fast-moving) objects, optionally pre-process the images, analyze the images to determine a classification, categorize and/or grade the objects, save the images and/or information generated from the analysis, and optionally generate reports based on the information generated from the analysis. Some examples of classifications (or classes, or categories, or grades) that the optical inspection systems and methods described herein can use are those related to quality (e.g., defective, non-defective), category (e.g., type-A, type-B), size (e.g., small, large), shape (e.g., round, square), color (e.g., white, black, uniform, non-uniform), or any other visual characteristic of the objects.

In some cases, the optical inspection systems and methods using the enhanced object detection models described herein can acquire images using digital cameras. In some cases, acquired images are stored using a hybrid in-memory and solid-state drive (SSD) storage system that enables the present systems to perform high-speed image acquisition and analysis. In some cases, the analysis is performed using artificial intelligence (AI) (e.g., AI-based object detection). Recording and/or writing reports for grading may also be done by the optical inspection systems and methods described herein, based on the analysis and/or grading performed. The analysis and/or grading may include adding bounding boxes around each object in an image, and determining a classification and/or grade for each object in an image or set of images.

In some cases, the optical inspection systems and methods using the enhanced object detection models described herein include offloading images (and optionally image data) to be written to memory (a storage system), and to a graphics processing unit (GPU), an application specific integrated circuit (ASIC), a central processing unit (CPU) and/or a field-programmable gate array (FPGA) for processing (e.g., the analysis and/or grading). Such systems can be fast enough to keep up with real-time object analysis (e.g., classifying and/or grading an object in under about 18 ms, or under about 20 ms).

In some cases, the optical inspection systems and methods using the enhanced object detection models described herein include 3D grading of both sides of fast-moving object(s).

The optical inspection systems and methods using the enhanced object detection models described herein can be used in logical inspection lines including 2 or more (e.g., from 2 to 10, or 6) image capture devices, processors, and/or storage devices (e.g., with components connected in parallel within a single device). Image capturing devices can be any devices capable of capturing a digital image, including digital cameras, charge-coupled device (CCD) cameras, and digital video recording devices (i.e., digital video cameras). The processor(s) can be any type or combination of processor(s) including, but not limited to CPU(s), GPU(s), ASIC(s), and FPGA(s). The storage systems can be any type of computer storage systems, such as (e.g., dynamic random access memory (DRAM) and/or a solid state-drive (SSD)). In such systems with multiple inspection lines, each line can have its own reporting and grading with its own camera(s), light(s), and/or mounting kit, that are all connected to a single device where the information (e.g., captured images, processed images, and/or information about the images) can be logically grouped and/or analyzed. For example, each logical inspection line can handle its own image capture (acquisition) and processing with 2 or more logical inspection lines sharing a processor (e.g., a FPGA, a CPU, and/or a GPU), and a storage system such as DRAM and/or an SSD. Such systems can be advantageous because they can reduce the total cost of the system, and can enable the inspection of more objects per a given interval of time. For example, in a process where multiple lines of objects converge into one line with a larger number of objects per unit time, multiple inspection lines (e.g., each having its own reporting and grading with its own camera(s), light(s), and/or mounting kit) placed on the multiple lines of objects (before converging) can enable all of the objects to be inspected, which may not be possible if one optical inspection system were installed on the converged line with a larger number of objects passing the system per unit time.

Additional descriptions of optical inspection systems and methods can be found in U.S. Pat. Pub. No. 2023/0080491 A1, which is hereby incorporated by reference in its entirety.

The optical inspection systems and methods using the enhanced object detection models described herein can be configured to inspect (fast-moving) objects in free fall (e.g., falling off a discharge chute) or to inspect objects on a horizontal conveyor belt. For example, the cameras can be positioned (e.g., facing approximately horizontally) to capture images of objects during free fall, or can be positioned (e.g., facing approximately downwards) to capture images of objects moving on a conveyor belt. In the case where there are multiple free fall lines (or streams) of objects, there can be a logical inspection line for each of the multiple free fall lines of objects, each sharing a processor and/or storage system as described above. Similarly, in the case where there are multiple lines (or streams) of objects moving on multiple conveyor belts, there can be a logical inspection line for each of the multiple lines of objects, each sharing a processor and/or storage system as described above.

In some cases, the object detection models described herein include deep learning models. In some cases, the object detection models include one or more of a family of object detection and tracking architectures and models that are pretrained on the common objects in context (COCO) dataset. In some cases, the object detection models include one or more deep learning object detection models such as Fast Region-based Convolutional Neural Network (Fast R-CNN) or Faster R-CNN, or regression-based object detectors such as a Single Shot Detector or YOLO.

Components of the optical inspection systems and methods using the enhanced object detection models described herein can be located either at the physical location of the objects being inspected, or they can be located in the cloud. Components that are located in the cloud are located at a physical location that is remote (or different than) the physical location of the objects being inspected. For example, a storage system or processor of the systems described herein that is located in the cloud can be located at a datacenter or other physical location away from the location of the objects being inspected. In the systems and methods described herein, components located in the cloud can be used to store or process information in the cloud. In some cases, data can be stored in the cloud using a cloud storage system (e.g., a cloud storage system from Microsoft, or Amazon Web Services).

In some cases, the object detection models described herein are trained using synthetic data. In some cases, the synthetic data can be obtained by 1) collecting representative objects, 2) taking images of the representative objects from different angles, 3) masking and/or cropping each of the images, 4) creating a 3D model of the images using photogrammetry, and 5) creating a set of training data images from the 3D model.

In some cases, from 10 to 500, from 20 to 100, or from 50 to 60 representative objects are collected, from which the synthetic data is generated. The representative objects can include multiple (e.g., about 10, or about 20, or from 10 to 30, or from 10 to 50, or from 10 to 100) objects from each of the different classifications (or classes, or categories, or grades) that the system will use. Some examples of classifications (or classes, or categories, or grades) are related to quality (e.g., defective, non-defective), category (e.g., type-A, type-B), size (e.g., small, large), shape (e.g., round, square), and color (e.g., white, black, uniform, non-uniform).

The images from different angles can be taken using a digital camera, and in some cases, using the same camera(s) that will be used on the actual optical inspection systems described herein. In some cases, the images are taken from about 20 (or about 10, or about 50, or from about 10 to about 100) different angles that encompass 360-degrees around an axis of the object. In some cases, a first set of images are taken from about 20 (or about 10, or about 50, or from about 10 to about 50) different angles that encompass 360-degrees around a first axis of the object, and a second set of images are taken from about 20 (or about 10, or about 50, or from about 10 to about 50) different angles that encompass 360-degrees around a second axis of the object. The first axis can be perpendicular to the second axis, or the first axis and the second axis can have an angle between them, such as an angle of 45 degrees or an angle between 0 degrees and 90 degrees. In some cases, a first set of images are taken from about 20 (or about 10, or about 50, or from about 10 to about 50) different angles in a first loop that surrounds the object (i.e., where the camera is approximately level with the object), and a second set of images are taken from about 20 (or about 10, or about 50, or from about 10 to about 50) different angles in a second loop that is located above the object (i.e., where the camera is above the object and oriented to capture images of the object from different angles from above).

In some cases, the same background and lighting conditions as will be used in the actual optical inspection system are used to generate the images for the training data. For example, if the color (or wavelength) of light is cool white during the actual data collection and object detection model inference by the optical inspection system, then it is desired to use the same cool white LED light during the synthetic data creation. In some cases, more than one light, or multiple lights, are used to simulate the actual lighting conditions (e.g., reflected light, multiple lights illuminating an object) used for one side or both sides of an object.

In some cases, the images are then masked and/or cropped to remove some or all of the background. For example, an image editing program (e.g., Adobe photoshop) can be used to mask and/or crop the images. In some cases, a portion (or all) of the background is removed and the object under question in the image is kept. The masking and/or cropping can improve the quality of the 3D model that will be created in the next step.

In some cases, a 3D model of each object is then created from the images of the object from different angles using photogrammetry (e.g., using Agisoft Metashape software). Photogrammetry is a tool by which one can create a virtual 3D model from a series of images taken at different angles.

Once the 3D models are created, then the synthetic images for the training data can be created from the 3D models (e.g., using 3D software, using 3D software developed for video games, and/or using Blender software). For example, a 3D model of an object can be used to create about 100, about 500, or from about 50 to about 1000, synthetic images from each of the 3D models. The synthetic images can be images of the object from many different angles, as might be seen in images taken by the actual optical inspection system during operation.

FIG. 3H shows an example of a 3D model of an object (an almond in this example) that was created using photogrammetry from images taken from many different angles. The 3D model was then used to create synthetic images of the object from different angles. FIG. 3I shows synthetic images of different objects (almonds in this example) from different angles that were generated using 3D gaming software (such as Blender or Unity from the 3D model generated using photogrammetry. Then, COCO tools can be used to create AI training data from the synthetic images (from the 3D gaming software). The created AI training data can include labels and bounding box information corresponding to the images that an AI training module can understand, which can save tens of days of person hours spent on annotation.

In some cases, the object detection model used in the systems and methods described herein are trained using synthetic data (e.g., generated as described above). The object detection model can be trained by 1) using synthetic data to train the object detection model, 2) collecting actual data using an optical inspection system described herein (e.g., during actual operation) and manually classifying some additional output data, and 3) improving the object detection model using the manually classified additional output data (i.e., using active learning).

Once the object detection model is trained using the synthetic data, the actual system can be used to generate an additional set of images for re-training and/or validating the object detection model using active learning. The additional collected images can be manually classified (and/or annotated), and the manually classified additional images can be used to re-train the object detection model and improve the accuracy (e.g., to greater than 90%, or to about 95% accuracy). In some cases, there may be from about 10,000 to about 100,000 (or about 50,000) total training images, and about 10% (or from about 5% to about 20%) of the training images are those that have been manually annotated for use in active learning, or to validate and/or to re-train the object detection model.

FIG. 3J shows an example of real images of objects (almonds in this example) taken by an actual optical inspection system, as described herein. Each of the images in FIG. 3J has been manually annotated by an operator to either validate or correct the output of the model trained using only synthetic data. An advantage of this approach is that the object detection model trained using synthetic data can draw bounding boxes and labels (e.g., indicating the classification, grade, or type of an object). This eliminates the need for time-consuming manual bounding box drawing, and all that is required at this stage is to validate or correct erroneous labels (e.g., about 30% to 40% of the errors from the object detection model trained using only synthetic data). This active learning process does rely on some manual annotation, however, since some of the processes have already been done (e.g., bounding box drawing and initial labeling), the total person hours required to train the object detection model using the present methods leveraging synthetic data is significantly reduced compared to that of an entirely manual annotation process to generate a set of training images. Using synthetic data to train the object detection models described herein can save a significant amount of time compared to manually determining a classification for every training image. For example, it may take 20-30 person days of annotation work to manually classify 20,000 to 50,000 training images, while generating classified training images using synthetic data (e.g., generated using the above method) can take significantly less resources (e.g., about 3 to about 10, or about 3 to about 5, or about 5, or about 10 person days).

The optical inspection systems and methods using the enhanced object detection models described herein can analyze images using the object detection model and produce reports containing classifications and/or grading information for objects in the images. In some cases, active learning (or incremental learning) is used to re-train the object detection model, wherein information in a report is manually modified (e.g., by an operator), and the modified data is sent to the object detection model to re-train the object detection model. The information in the report can be manually modified, for example, to regroup the information, and/or to change one or more labels associated with images or objects. In some cases, such active learning methods are performed on systems with storage systems and/or processors that are in the cloud. For example, the modified information can be saved to a storage system in the cloud, and a processor in the cloud can be configured to re-train the object detection model, and then the re-trained object detection model can be provided to one or more processors of the optical inspection system to be used to analyze images.

In some cases, classes or categories of objects can be further subdivided into sub-categories. For example, the dataset can be images of fish, the categories can be different species of fish, and the sub-categories can be different colors of the species, or different sizes of the species. In another example, the dataset can be images of almonds, the categories can be different types of defects of almonds (e.g., broken, discolored, foreign matter) and the sub-categories can be the severity, or the amount of the almond that is affected by the defect.

In some cases, a logic-based model can be used with a general object detection model to detect the category and sub-category of an object. For example, logic-based models can be used to detect a color of an object. Additionally, a logic-based model, optionally working together with an object detection model, can be used to create enhanced training data with labels that include the category and sub-category of the objects. Using such a combination of object detection models and logic-based models to create training datasets can be beneficial to train models to detect the sub-categories, and to avoid errors typical in training data labeled by humans.

In some cases, a specialized object detection model (e.g., a large, or slow AI model) can be used to learn on a few images which can then be used to create a large set of training images, which can then be used to train an enhanced object detection model (e.g., an actual inspection or sorting model running in production sites). In some cases, large object detection models are not pragmatic in terms of real-time inference, thermal usage, and computing hardware requirements. However, in such cases they are practical to use to create custom training datasets using fewer images. This can be advantageous, since a few manually labeled training images can be used to generate a large dataset of training images.

For the deep learning models described herein, training mode refers to a mode used to teach the model to recognize categories of objects, and inference mode refers to a mode used to apply the learnings to detect objects in candidate images. During training mode, labeled data is provided to a deep learning object detection model and the model learns to recognize objects by adjusting model parameters (e.g., weights) to minimize the difference between predicted outputs and the known labels. For example, the training process can include forward passes of input images through a network of the model, followed by backpropagation of errors to update the weights. In contrast, during inference mode, a trained object detection model is presented with data to be analyzed and the model is used to predict bounding boxes and category probabilities for detected objects in the data.

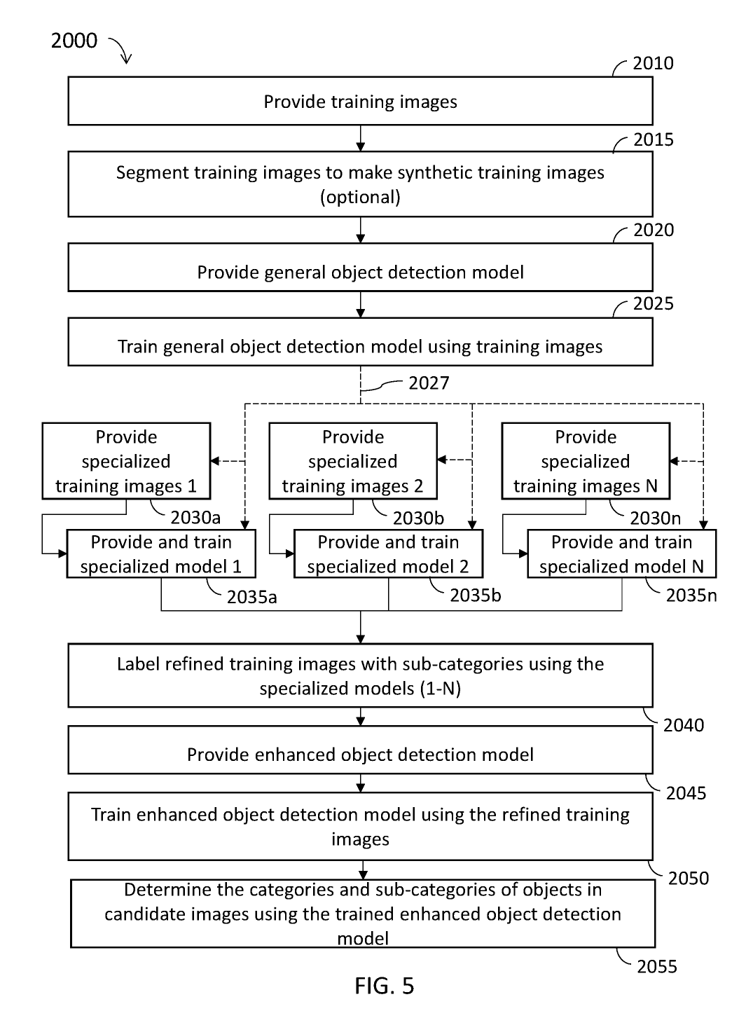

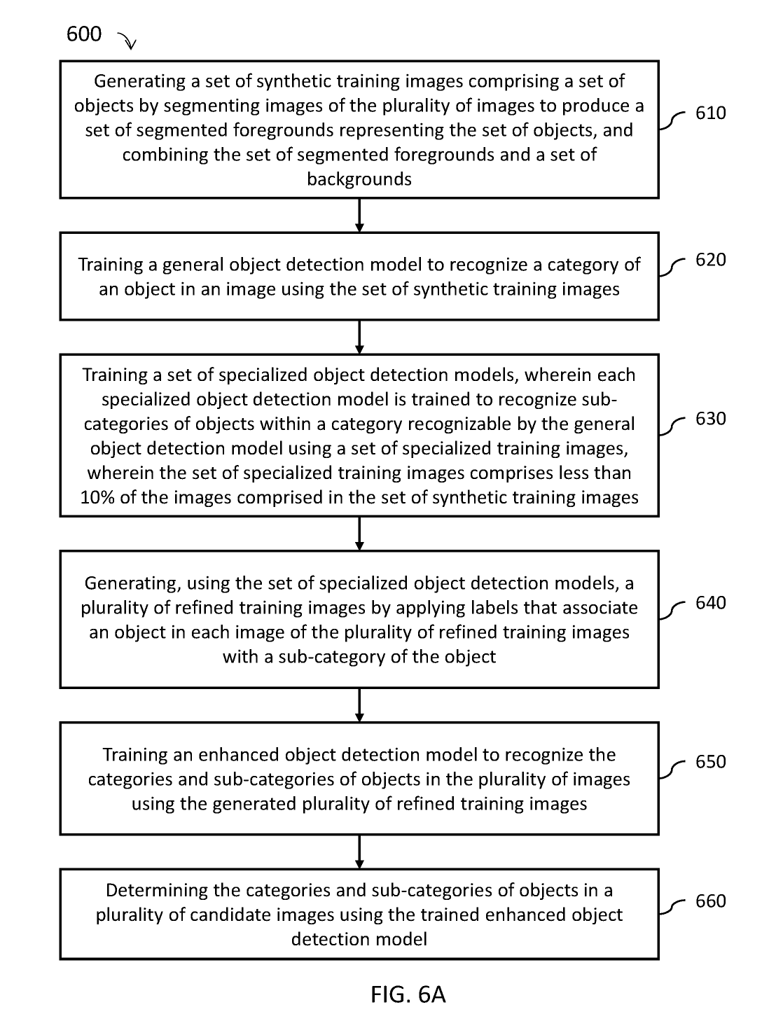

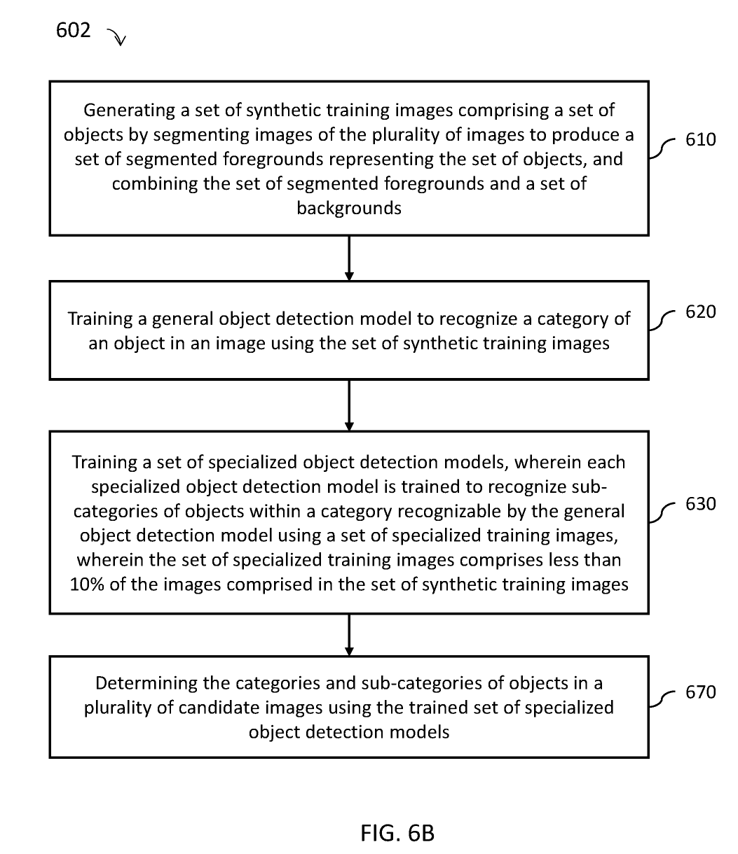

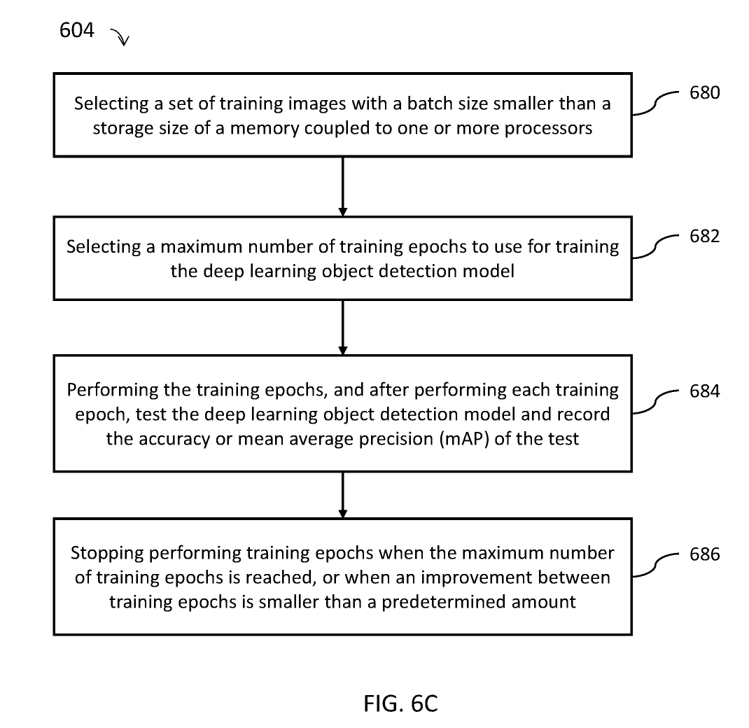

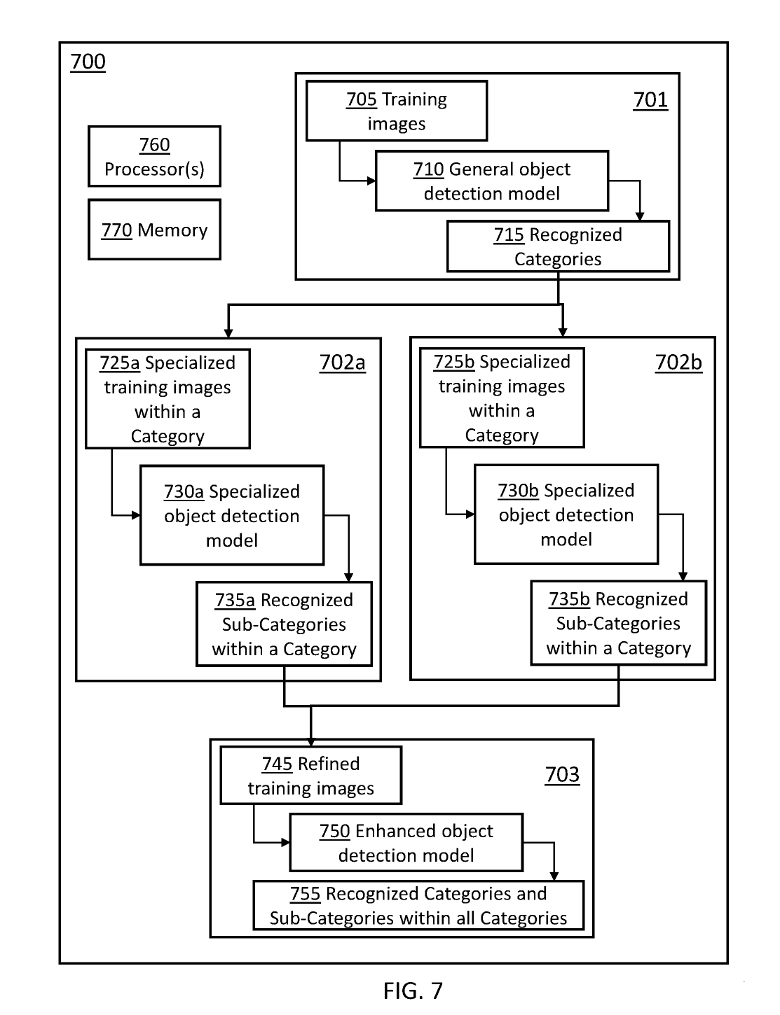

In some cases, large object detection models, such as vision transformer-based models and agentic object detection models that use reasoning-driven AI, agentic patterns, and intrinsic attribute recognition, can be used for real-time inference if adequate computing hardware is used. For example, the enhanced object detection models described herein can use such large object detection models in some cases. For example, the enhanced object detection model in blocks 2045, 2050, 2055 of FIG. 5, in blocks 650, 660 of FIG. 6A, and/or in block 750 of FIG. 7 can use such large object detection models in some cases (e.g., if adequate computing hardware is used).

This approach has an additional benefit - its flexibility. Once categories are established and models trained, they can be rapidly refined to address any remaining accuracy gaps and meet specific object detection performance targets. This enables swift model updates, making it possible to implement practical and economically viable inspection systems that align with business objectives.

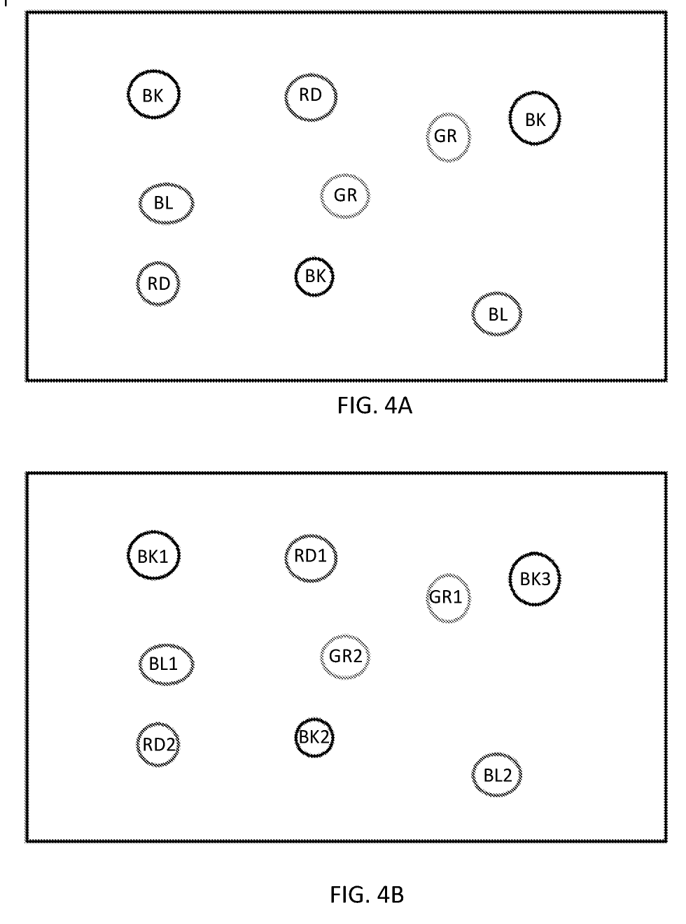

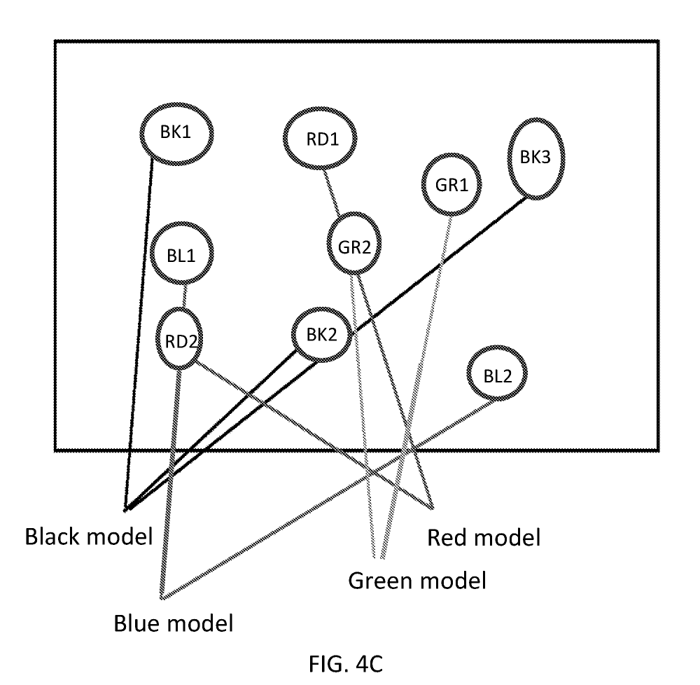

FIGS. 4A and 4B show examples of images with objects and their associated labels overlaid on the image. In FIG. 4A, there are four object categories - black (“BK”), red (“RD”), blue (“BL”), and green (“GR”). The categories can represent different categories of defect types, types of object, sizes of objects, or any physical classification (e.g., species of fish). FIG. 4B shows the same categories, with additional sub-categories associated with each object. There are three sub-categories within the black category, shown as “BK1,” “BK2,” and “BK3.” Each of these sub-categories “BK1,” “BK2,” and “BK3” are within the black category. Similarly, there are two sub-categories within the red category, shown as “RD1,” and “RD2”; two sub-categories within the blue category, shown as “BL1,” and “BL2”; and two sub-categories within the green category, shown as “GR1,” and “GR2.”

Conventionally, the labeling done in FIGS. 4A and 4B are done by humans, which are prone to error.

FIG. 4C shows an example of an alternative approach to automatically generating a large set of training images using specialized models. In this example, a specialized model (“Black model”) is trained to recognize sub-categories within the category of “black” objects, another specialized model (“Blue model”) is trained to recognize sub-categories within the category of “blue” objects, another specialized model (“Green model”) is trained to recognize sub-categories within the category of “green” objects, and another specialized model (“Red model”) is trained to recognize sub-categories within the category of “red” objects.

The systems and methods described herein use specialized models (e.g. rule-based models, large language models (LLMs), and/or few shot learning models) that can learn more accurately from fewer samples. These specialized AI models can be created for each category and used to generate labeled training images including objects from a category that are labeled with category and sub-category. For example, a general object detection model can be used to recognize categories of objects in a set of training images, and assign labels corresponding to the category to the objects in the images. These labeled images can then be further classified into sub-categories using the specialized models, and sub-categories can be added to the labels. These further labeled training images can then be used to train a fast and efficient object detection model to learn to recognize objects within categories and sub-categories.

In the example in FIGS. 4A and 4B, four specialized models, one for each category (black, red, blue, and green) can be trained to recognize categories and sub-categories of objects. In some cases, these specialized models are not suitable to run in production (e.g., due to computing and thermal requirements). However, they can be used to generate labeled training data quickly, which can be used to create custom training datasets for object detection models that can run fast and efficiently enough for real time use in a production environment. In other cases, given adequate computing hardware and thermal budget, the same models used by the specialized models described herein can be used as the enhanced object detection models for real-time inference.

In the example in FIGS. 4A and 4B, one or more rule-based models can be used instead of specialized models to recognize categories and sub-categories of objects. Rule-based logic can sometimes perform as well as, or better than AI models, for example in one dimensional tasks such as detecting color tones. These rule-based models can then be used to generate labeled training data quickly, which can be used to create custom training datasets for object detection. In some cases, rule-based models can be used together with AI-based object detection models.

In some cases, such as that shown in FIG. 4B, there can be many different categories and sub-categories of objects in a single image. The systems, models, and methods described herein can include using specialized models to detect sub-categories of objects within a single category. Those trained specialized models can then be used to automatically label a large number of images with sub-categories within a single category. A set of specialized models can be used to automatically label a large number of images with sub-categories within a whole set of categories.

In some cases, the images labeled using the specialized models can then be segmented to separate the object foregrounds. The labeled object foregrounds from many categories can then be combined with backgrounds to form synthetic images with many different categories and sub-categories, for example, as shown in FIG. 4B. These types of images can then be used to train an enhanced object detection model, which can detect all of the categories and sub-categories.

In some cases, a general object detection model (such as those described above) can be trained using synthetic data to achieve about 80% accuracy. For example, an initial set of real-world images or datasets can be obtained (e.g., from publicly available repositories, CAD models, or in-house image data). Each of these real-world images can be segmented to isolate the foreground objects (e.g., a fish) from the background, for example, using a CNN such as Mask-CNN or Mask-RCNN.

The foreground objects produced using segmentation are combined with different backgrounds to generate a set of synthetic training images. The different backgrounds can be randomly selected or algorithmically generated to produce a diverse set of synthetic training images. The synthetic training images can also simulate real-world variability, including lighting conditions, object positions, occlusions (in some cases objects occlude one another in the images), and partially depicted objects. To further enhance diversity, techniques such as domain randomization and Gaussian blurring may be applied to mimic real-world data noise to generate the set of synthetic training images.

An advantage of the synthetic image generation method described above is that a large number of different training images can be generated from a small number of manually labeled real-world images. In other words, a majority of the labeling process is automated by this method, which drastically reduces the time and human effort needed to prepare datasets for model training. In some cases, the use of synthetic training data enables the general object model to achieve an accuracy of up to 80% (e.g., within a few days or weeks of training), depending on the complexity of the objects being detected. In cases where rare objects or defects are involved, the synthetic data generation process can also help address data imbalance issues by generating additional training images including the defect from a small number (e.g., less than 10, or less than 5) real-world images of the defect.

In some cases, a set of specialized models can be used in concert with a general object detection model to improve the detection accuracy to over about 90%. For example, specialized models can be trained using few-shot learning techniques. The specialized models can be highly efficient at learning from small datasets, enabling the model to quickly generalize and detect subtle differences between object sub-categories (e.g., variations in defects or object types). The specialized models can be trained using few-shot learning techniques where a small number of labeled examples (e.g., less than about 20, less than about 10, or less than about 5 per category) are used to train the model. For example, the sub-category can be color, and the specialized models can be trained to detect specific color tones of objects. In such cases, a few examples of different sub-categories (e.g., shades of black) can be used to train the specialized model. Once the model is trained, then a set of real-world or synthetic images can be labeled with a category and a sub-category using the specialized model to produce a set of refined training images that are labeled with the category and sub-category of each object in the images.

In addition to synthetic data and few-shot learning, specialized models can also include rule-based logic. For example, rule-based models can be used for one-dimensional tasks, such as color detection. This rule-based approach further minimizes the need for manual intervention, providing an additional layer of accuracy for tasks that do not require complex deep learning models.

The labeled refined training images can then be used to train a general object detection model to achieve greater than 90% accuracy due to the improved labeling of the refined training images, and such that it can be referred to as an enhanced object detection model as described above. In some cases, the enhanced model is significantly smaller and faster compared to conventional models, making it possible to use in scenarios with limited computational resources. During training, parallel processing across multiple nodes can be used. For example, each node can have about 100 GB of memory, and about 1000 nodes can be used to train a model. More than 1000 nodes can be used, with more than 100 GB of memory each, which will make the training go faster. In inference mode, when inspecting or sorting objects (e.g., in real-time) then a processing and memory storage system with about 1000 parallel cores can be used. The memory storage of the 1000 parallel core system can be about 24 GB. In inference mode, more computing power will enable the optical inspection system to inspect more objects per second. Conventional systems are not capable of real-time inspection and sorting using large object detection models (e.g., transformer-based models) due to the inability to meet the computing and thermal requirements. However, any of the object detection models described herein, including large object detection models, can be used in inference mode for real-time inspection and sorting if adequate computing hardware is available.

In some cases, a method for improving the accuracy of a deep learning model used for object detection and segmentation, comprises: generating synthetic training data to train the model from 0% to 80% accuracy; and applying specialized models trained through few-shot learning to generate additional data, improving accuracy to over 90%.

In some cases, the synthetic images are generated by fusing segmented foreground objects with randomized or algorithmically selected backgrounds.

In some cases, the few-shot learning models are trained using fewer than 10 labeled examples and used to generate additional synthetic training data.

In some cases, a final production model is trained using the additional labeled data generated by the few-shot learning models, and can be used for real-time inference. In some cases, the final production model also has a low computational overhead.

In some cases, one or both of the specialized models and the final production model includes rule-based logic for one-dimensional tasks, such as color detection, to improve accuracy without additional manual labeling.

FIG. 5 shows an example flowchart of a computer-implemented method 2000 for training an object detection model to recognize the category and sub-category of objects in digital images. Method 2000 can be performed using one or more processors, which can be any type of processor(s), such as CPU(s)) GPU(s), and FPGA(s).

In block 2010, training images are provided. In block 2015, the training images are optionally segmented, and synthetic training images are created. In block 2020, a general object detection model is provided. In block 2025, the general object detection model is trained, using the training images, to recognize a category of objects shown in the training images. In some cases, the general model can correctly determine the category of an object with a mean average precision (mAP) of approximately 80% after the training in block 2025. Some examples of the general object detection model are one or more of: a deep learning object detection model, a convolutional neural network, a region-based convolutional neural network (R-CNN), a Fast R-CNN, a Faster R-CNN, and a regression-based object detection model. In some cases, general object detection model in block 2025 can include one or more of: a vision transformer-based model and an agentic object detection model that uses reasoning-driven AI, agentic patterns, and intrinsic attribute recognition. In some cases, one or more rule-based models, or a combination of deep learning and rule-based models can be provided and used as the general object detection models in blocks 2020 and 2025. In some cases, general object detection model can utilize zero-shot object detection, and blocks 2010, 2015, 2020, and 2025 can be omitted. In this case, one or more of: the vision transformer-based model and the agentic object detection model can be used to inform the inform the providing of the set of specialized models in blocks 2035a, 2035b, 2035n, and the specialized training images in blocks 2030a, 2030b, 2030n as indicated by dotted arrows 2027.

In blocks 2035a, 2035b, and 2035n, a set of specialized models are provided. Each specialized model can be used to recognize a sub-set of objects in the training images. For example, each specialized model can correspond to a different category of object in the training images. In blocks 2030a, 2030b, 2030n, specialized training images are provided to each specialized model, where the specialized images include objects that are in the sub-set of objects that the specialized model can recognize. In some cases, a small number (e.g., from 1 to 100, or from 2 to 10, or from 2 to 5) specialized training images are provided to each specialized model. In blocks 2035a, 2035b, 2035n each specialized model is also trained, using the specialized training images, to recognize sub-categories of the objects shown in the specialized training images. Some examples of the specialized models are few-shot learning models, single-shot detector models, detection transformer (DETR) models, you only look once (YOLO) models, DETR with improved denoising anchor boxes (DINO) models, DINOv2 models, contrastive language-image pre-training (CLIP) models, Few-CLIP models, rule-based models, classification models, or combinations thereof. In some cases, specialized object detection models in blocks 2030a, 2030b, 2030n can include one or more of: a vision transformer-based model and an agentic object detection model that uses reasoning-driven AI, agentic patterns, and intrinsic attribute recognition. In some cases, the specialized object detection models in blocks 2030a, 2030b, 2030n can utilize zero-shot object detection. Three specialized models are shown in the method 2000, however, from about 2 to about 10, from about 10 to about 100, from about 10 to about 1000, or more than 1000 specialized models, can be used in method 2000.

In some cases, the trained object detection model in block 2025 is used to inform the providing of the set of specialized models in blocks 2035a, 2035b, 2035n, and the specialized training images in blocks 2030a, 2030b, 2030n as indicated by dotted arrows 2027. For example, the number and types of categories of objects detected by the object detection model in block 2025 can indicate the number and types of specialized models provided in blocks 2035a, 2035b, 2035n. In another example, foregrounds of the images in a particular category can be detected in the object detection model in block 2025 and those foregrounds can be used to generate synthetic data to train the specialized models provided in blocks 2035a, 2035b, 2035n. In some cases, a human can label the newly made synthetic images, for example, associating objects in the images with sub-categories.

In block 2040, the trained specialized models are used to label refined training data. The refined training data can be labeled with the category and sub-category of each object in each image. In block 2045, an enhanced object detection model can be provided, and in block 2050, the enhanced objected detection model can be trained to recognize a category and sub-category of objects shown in the enhanced training images. In some cases, the enhanced model can correctly determine the category of an object with a mean average precision (mAP) of approximately 90%, or greater than 90%, or greater than 95%, after the training in block 2050. Some examples of the enhanced object detection model are one or more of: a deep learning object detection model, a convolutional neural network, a region-based convolutional neural network (R-CNN), a Fast R-CNN, a Faster R-CNN, and a regression-based object detection model. Some examples of the enhanced object detection model include one or more of: a deep learning object detection model, a convolutional neural network, a region-based convolutional neural network (R-CNN), a Fast R-CNN, a Faster R-CNN, and a regression-based object detection model. In some cases, the enhanced objected detection model in blocks 2045 and 2050 can include one or more of a vision transformer-based model and an agentic object detection model that uses reasoning-driven AI, agentic patterns, and intrinsic attribute recognition. In some cases, one or more rule-based models, or a combination of deep learning and rule-based models can be provided and used as the general object detection models in blocks 2045 and 2050. In block 2055, the categories and sub-categories of objects in one or more candidate images are determined (i.e., in inference mode) using the trained enhanced object detection model.

In some cases, blocks 2010, 2015, 2020 and 2025 can be omitted from method 2000, and method 2000 can start at blocks 2030a, 2030b, 2030n. In this case, the set of specialized models in blocks 2035a, 2035b, 2035n, and the specialized training images in blocks 2030a, 2030b, 2030n can be provided based on other criteria, such as domain knowledge or empirical data of the categories and sub-categories of objects that are to be detected. In this example, In block 2040, the trained specialized models can still be used to label refined training data with the category and sub-category of each object in each image. In block 2045, an enhanced object detection model can be provided, and in block 2050, the enhanced objected detection model can be trained to recognize a category and sub-category of objects shown in the enhanced training images. Therefore, blocks 2010, 2015, 2020 and 2025 can be omitted, and still in some cases, the enhanced model can correctly determine the category of an object with a mean average precision (mAP) of approximately 90%, or greater than 90%, or greater than 95%, after the training in block 2050. Some examples of the enhanced object detection model are one or more of a deep learning object detection model, a convolutional neural network, a region-based convolutional neural network (R-CNN), a Fast R-CNN, a Faster R-CNN, and a regression-based object detection model.

In some cases, the categories and sub-categories of objects in a plurality of candidate images can be determined directly using the trained set of specialized object detection models in blocks 2035a, 2035b, 2035n. For example, the trained set of specialized object detection models in blocks 2035a, 2035b, 2035n can be used to detect objects in a real-time visual inspection system for a manufacturing facility or processing plant. In other words, the trained set of specialized object detection models in blocks 2035a, 2035b, 2035n can be used in inference mode (e.g., for real-time inspection or sorting). In such cases, blocks 2040, 2045, and 2050 may be optional and/or can be omitted from method 6000.

FIGS. 6A and 6B are flowcharts of example methods for using a deep learning object detection model to categorize objects in images using one or more processors coupled to memory. The processor(s) can be any type of processor(s), such as CPU(s)) GPU(s), and FPGA(s), and the memory can be any type of memory, such as DRAM and/or an SSD.

FIG. 6A is a flowchart of an example method 600 for using a deep learning object detection model to categorize objects in images using one or more processors coupled to memory. At block 610 of computer-implemented method 600, a set of synthetic training images including a set of objects is generated by segmenting images to produce a set of segmented foregrounds of the set of objects, and combining the set of segmented foregrounds and a set of backgrounds. At block 620, a general object detection model is trained to recognize a category of an object in an image using the set of synthetic training images. In other examples, the general object detection model in block 620 can be trained using training images that include real-world images that are not synthetically generated, or a mixture of real-world and synthetically generated images.

At block 630, a set of specialized object detection models is trained, wherein each specialized object detection model is trained to recognize sub-categories of objects within a category recognizable by the general object detection model using a set of specialized training images. The set of specialized training images can include less than about 1%, less than about 5%, or less than about 10%, or less than about 20% of the images comprised in the set of synthetic training images. At block 640, a plurality of refined training images is generated by applying labels that associate an object in each image of the plurality of refined training images with a sub-category of the object using the set of specialized object detection models. At block 650, an enhanced object detection model is trained to recognize the category and sub-category of objects in a plurality of images (e.g., candidate images) using the plurality of refined training images. At block 660, the categories and sub-categories of objects in the plurality of candidate images are determined using the trained enhanced object detection model.

FIG. 6B is a flowchart of an example method 602 for using a deep learning object detection model to categorize objects in images using one or more processors coupled to memory. Computer-implemented method 602 may include blocks 610, 620 and 630, as described above with respect to method 600 in FIG. 6A. In block 670, the set of specialized object detection models are directly used in inference mode to determine categories and sub-categories of objects in a plurality of candidate images. In method 602 blocks 640, 650, or 660 related to the enhanced object detection model may be optional and/or omitted from method 602.

FIG. 6C is a flowchart of an example method 604 for training a deep learning object detection model to categorize objects in images using one or more processors coupled to memory. For example, computer-implemented method 604 can be used to train the deep learning object detection models in method 2000 blocks 2025, 2035a, 2035b, 2035c, and 2050, or in methods 600 or 602 blocks 620, 630, and 650. At block 680 a set of training images is selected with a batch size smaller than a storage size of the memory. For example, a GPU can be used to perform method 604, and the memory can be DRAM. The batch size is the total size of all of the images in the set of training images, and is therefore dependent on the number of images in the set of training images and the size of each image in the set of training images. The size of each image in the set of training images is dependent on factors such as the number of pixels, the image file format, and optionally compression settings.

At block 682, a maximum number of training epochs is selected to use for training the deep learning object detection model. For example, from about 5 to more than 1000, from about 5 to about 100, from about 5 to about 50, less than about 10, less than about 50, or less than about 1000 training epochs can be used in block 682. At block 684 the training epochs are performed. After performing each training epoch, the deep learning object detection model is tested, and the accuracy or mean average precision (mAP) of the test is recorded.

At block 686, the training is stopped when the maximum number of training epochs is reached, or when an improvement between training epochs is smaller than a predetermined amount. The improvement can be a difference between an mAP of the test after the previous epoch and the mAP of the test after the current epoch. For example, the training can be stopped when the maximum number of training epochs is reached, or when an improvement between training epochs is smaller than about 2%, smaller than about 1%, smaller than about 0.5%, or smaller than about 0.1%. In some cases, an average improvement over more than one epoch is used as a threshold to stop the training. For example, the training can be stopped when the maximum number (or other predefined number) of training epochs is reached, or when an average improvement over 5 (or over 3, or over 10) training epochs is smaller than about 2%, smaller than about 1%, smaller than about 0.5%, or smaller than about 0.1%. In some cases, the best mAP is stored after each test, and if the best score is not surpassed in 5, or 10, or 20 epochs, then the training is stopped.

In some cases, previously generated reports and/or data from one or more of the systems described herein are archived automatically to a storage system in the cloud. For example, all reports and data (e.g., images, bounding box location, and/or grades) from systems of a single customer (or operator, or owner) can be centrally stored in a cloud storage (e.g., a cloud storage system from Microsoft, or Amazon Web Services). In some cases, an operator can access the reports and/or data in the cloud, and obtain relevant quality grading or inspection metrics. Using such systems and methods, an operator can be provided with information that is useful for them (e.g., for QC) without having any data science skills or other software (e.g., Jupyter) knowledge. In some cases, an operator can use their domain knowledge to review and (quickly and easily) add, remove, and/or edit the grades in reports and/or data in the cloud. In some cases, updated reports and/or data used for active learning (e.g., including revised grade and/or other label information added, removed or edited by the operator) can be automatically stored in a centralized cloud database. The new information may then trigger a new AI model training for one or more of the systems of the customer (or operator, or owner). Archived data in the cloud can also be used to show historical trends over time (e.g., hours, days, months, or years). In some cases, aggregate reports can be created from the reports and/or data in the cloud, for example, that combine data from multiple optical inspection systems (and/or lines, and/or facilities), or that contain data that has been filtered (e.g., by system, location, etc.).

FIG. 7 shows a schematic of an example of an object detection system 700. The object detection system 700 includes one or more processors 760 and memory 770. The processors 760 may include one or more processors that include one or more devices capable of executing instructions, such as instructions stored by the memory 770 to perform any of the methods described herein. For example, the instructions stored by the memory 770, can cause the processor(s) 760 to perform method 2000 in FIG. 5, or method 600 in FIG. 6A.

Processing block 701 in object detection system 700 includes a general object detection model 710, which can be trained using training images 705. Training images 705 can be synthetic images including segmented foregrounds and backgrounds, as described herein. In operation of system 700, processors 760 may train the general object detection model 710 to recognize categories 715 using the training images 705. The general object detection model 710 can be one or more of a deep learning object detection model, a convolutional neural network, a region-based convolutional neural network (R-CNN), a Fast R-CNN, a Faster R-CNN, or a regression-based object detection model. In some cases, the general object detection model 710 can include one or more of a vision transformer-based model and an agentic object detection model that uses reasoning-driven AI, agentic patterns, and intrinsic attribute recognition. In some cases, the general object detection model 710 can include zero-shot object detection, and the training images 705 can be omitted. In some cases, general object detection model 710 can include one or more rule-based models, or a combinations of deep learning and rule-based models.

Processing blocks 702a, 702b in object detection system 700 include two different specialized object detection models 730a, 730b, each of which can be trained using specialized training images 725a, 725b. Specialized training images 725a can include objects from a first category that is recognizable by the general object detection model 710. Specialized training images 735a can include objects from a second category that is recognizable by the general object detection model 710. For simplicity, FIG. 7 depicts two specialized object detection models 725a, 725b, however, in practice, there can be from about 2 to about 10, or from about 2 to about 100 specialized models, or more than 100 specialized object detection models, each one corresponding to a different category in the recognized categories 715. The specialized training images 725a, 725b can be synthetic images including segmented foregrounds and backgrounds, as described herein. In operation of system 700, processors 760 may train the specialized training models 730a, 730b to recognize sub-categories of object within a category 735a, 735b using the specialized training images 725a, 725b. The specialized object detection models 730a, 730b can include a few-shot learning model, a single-shot detector model, a detection transformer (DETR) model, a you only look once (YOLO) model, a DETR with improved denoising anchor boxes (DINO), a DINOv2 model, a contrastive language-image pre-training (CLIP) model, a Few-CLIP model, a rule-based model, a classification model, or a combination thereof.

Processing block 703 in object detection system 700 includes an enhanced object detection model 750, which can be trained using refined training images 745. Refined training images 745 can be generated using the specialized training models 730a, 730b by applying labels that associate an object in each image of the plurality of refined training images 745 with a sub-category of the object. Training images 745 can be synthetic images including segmented foregrounds and backgrounds, as described herein. In operation of system 700, processors 760 may train the enhanced object detection model 750 to recognize categories and sub-categories 755 using the refined training images 745. The enhanced object detection model 750 can be one or more of a deep learning object detection model, a convolutional neural network, a region-based convolutional neural network (R-CNN), a Fast R-CNN, a Faster R-CNN, or a regression-based object detection model. In some cases, the enhanced object detection model 750 can include one or more of a vision transformer-based model and an agentic object detection model that uses reasoning-driven AI, agentic patterns, and intrinsic attribute recognition. In some cases, enhanced object detection model 750 can include one or more rule-based models, or a combinations of deep learning and rule-based models.

Once the enhanced object detection model 750 is trained, then system 700 can be used to recognize categories and sub-categories of objects within all of the categories corresponding to a set of candidate images. For example, processors 760 may use the enhanced object detection model 750 to recognize categories and sub-categories of objects in a set of candidate images.

In some cases, the categories and sub-categories of objects in a plurality of candidate images can be determined directly using the trained set of specialized object detection models 730a, 730b. In some cases, the trained set of specialized object detection models 730a, 730b can be used in inference mode (e.g., for real-time inspection or sorting). In such cases, processing block 703 is not required and can be omitted.

The memory 770 can include one or more non-transitory computer-readable storage media. The memory 770 may store instructions and data that are usable in combination with processor(s) 760 to execute the processes and/or algorithms described herein as well as to execute or interface with object detection models in processing blocks 701, 702a, 702b, and 703. The memory 770 may also function to store or have access to object detection models in processing blocks 701, 702a, 702b, and 703.

In some cases, the one or more processors 760 and memory 770 can include a first-stage storage system configured to store images (e.g., from a database of images, or from one or more image capturing devices). The one or more processors 760 and memory 770 can further include a second-stage processor coupled to the first-stage storage system and configured to analyze the images from the one or more image capturing devices. A second-stage storage system can be coupled to the second-stage processor and be configured to store images and information from the second-stage processor. A third-stage processor can be coupled to the second-stage storage system and be configured to process information from the second-stage processor and second-stage storage system and produce a report. A third-stage storage system also be coupled to the third-stage processor and be configured to store images and information from the third-stage processor. In object detection system 700, the second-stage processor can be configured to analyze the images using the general object detection model 710, the specialized object detection models 730a, 730b, and/or the enhanced object detection model 750.

In some cases, the one or more processors 760 and memory 770 can include a volatile memory system configured to store images (e.g., from a database of images, or from one or more image capturing devices). The one or more processors 760 and memory 770 can further include a first second-stage processor coupled to the volatile memory system configured to analyze the images from the one or more image capturing devices, and a second second-stage processor coupled to the first second-stage processor configured to process information from the first second-stage processor. A third-stage storage system can be coupled to the second second-stage processor and be configured to store images and information from the second second-stage processor. The second second-stage processor can be configured to produce a report using the images and information stored in the third-stage storage system. The second-stage processor can be configured to analyze the images from the one or more image capturing devices using the general object detection model 710, the specialized object detection models 730a, 730b, and/or the enhanced object detection model 750.

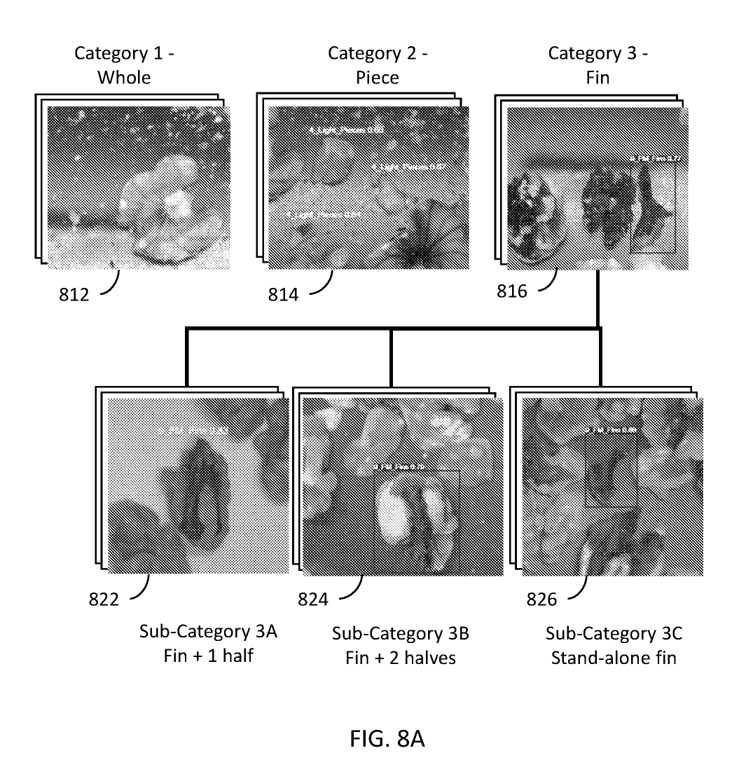

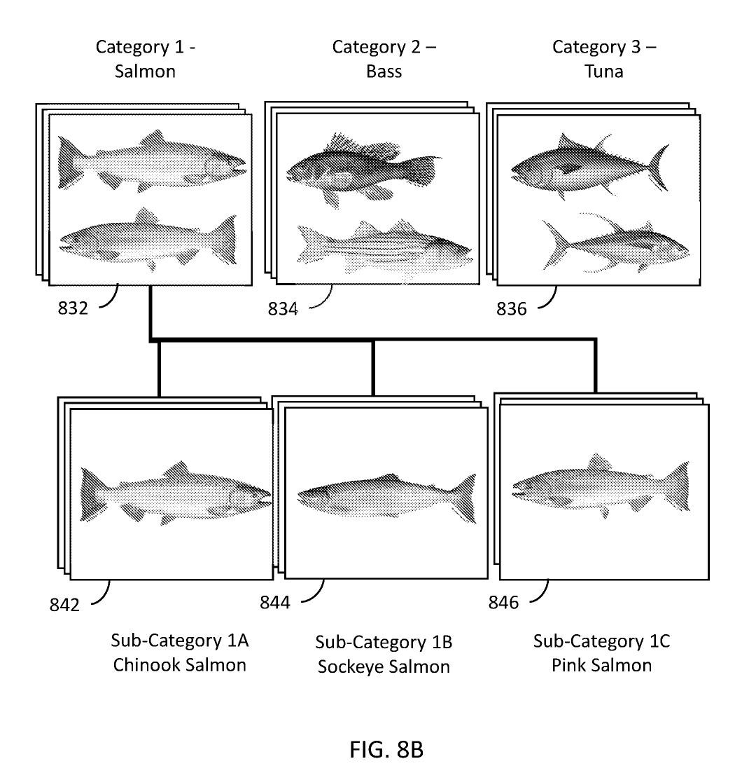

FIGS. 8A and 8B show examples of images including objects in different categories and sub-categories, which are walnuts or portions of walnuts in FIG. 8A and fish in FIG. 8B. The images in FIGS. 8A and 8B are examples of a set of images that can be categorized into categories and sub-categories using methods 2000, 600, 602, and 604 in FIGS. 5 and 6A-6C, and using system 700 in FIG. 7. The images in FIGS. 8A and 8B are also example sets of images that can be used to train deep learning object detection models, for example, using methods 2000, 600, 602, and 604 in FIGS. 5 and 6A-6C, and using system 700 in FIG. 7.

There can be one or more images in each of the categories and sub-categories of the images in FIGS. 8A and 8B. For example, in FIG. 8A there can be one or more images 812 with walnuts in the “whole” category. In each category and in each sub-category of images in FIGS. 8A and 8B, there can be from about 1 to about 1000, from about 5 to about 1000, from about 10 to about 1000, from about 1 to about 100, from about 5 to about 100, from about 1 to about 10, from about 5 to about 10, less than about 10, less than about 100, less than about 1000, greater than about 1000 images, or greater than about 10,000 images.

FIG. 8A shows an example of a set of images of walnuts in different categories and sub-categories. The categories are “Whole,” “Piece,” and “Fin,” shown in respective images 812, 814, and 816. Sub-categories within the “Fin” category are “Fin + 1 half,” “Fin + 2 halves,” and “Stand-alone fin,” as shown in respective images 822, 824, and 826.

The images 812, 814, and 816 in different categories of walnuts can be provided or selected as training images, for example, in method 2000 block 2010, in method 604 block 680, or in system 700 block 705. The objects (i.e., walnuts) in the images 812, 814, and 816 can be labeled with the categories and used to train a general object detection model, for example, in method 2000 block 2025, or in methods 600 or 602 block 620. Likewise, images 812, 814, 816 can be used as training images in method 604.

The images 822, 824, and 826 of sub-categories of fins of walnuts can be provided or selected as training images, for example, in method 2000 blocks 2030a, 2030b, 2030n, or in system 700 blocks 725a and 725b. The objects (i.e., fins) in the images 822, 824, and 826 can be labeled with the sub-categories and used to train a specialized object detection model, for example, in method 2000 blocks 2035a, 2035b, 2035n, or in methods 600 or 602 block 630. Likewise, images 822, 824, 826 can be used as training images in method 604.

FIG. 8B shows an example of a set of images of fish in different categories and sub-categories (images source: National Oceanic and Atmospheric Administration (NOAA), 2025). The categories are general types of fish, in this case “Salmon,” “Bass,” and “Tuna,” shown in respective images 832, 834, and 836. Sub-categories within the “Salmon” category are more specific types of fish “Chinook salmon,” “Sockeye salmon,” and “Pink salmon,” as shown in respective images 842, 844, and 846. In other examples, the sub-categories could be different sizes of salmon.

The images 832, 834, and 836 of different categories of fish can be provided or selected as training images, for example, in method 2000 block 2010, in method 604 block 680, or in system 700 block 705. The objects (i.e., fish) in the images 812, 814, and 816 can be labeled with the categories and used to train a general object detection model, for example, in method 2000 block 2025, or in methods 600 or 602 block 620. Likewise, images 812, 814, 816 can be used as training images in method 604.

The images 842, 844, and 846 of sub-categories of salmon can be provided or selected as training images, for example, in method 2000 blocks 2030a, 2030b, 2030n, or in system 700 blocks 725a and 725b. The objects (i.e., salmon) in the images 822, 824, and 826 can be labeled with the sub-categories and used to train a specialized object detection model, for example, in method 2000 blocks 2035a, 2035b, 2035n, or in methods 600 or 602 block 630. Likewise, images 822, 824, 826 can be used as training images in method 604.

In the methods and systems described herein, the training images can be synthetic images generated using one or more object detection models by segmenting the foregrounds from the starting images, associating a category with an object in the segmented foreground, and combining the categorized foreground images with backgrounds to generate labeled synthetic training images. At least some of the training images in one or more of blocks 2010, 2015, 2030a, 2030b, 2030n, and 2040 of method 2000 in FIG. 5, blocks 610, 630, and 640 of methods 600 and 602 in FIGS. 6A and 6B, block 680 of method 604 in FIG. 6C, and blocks 705, 725a, 725b, and 745 of system 700 in FIG. 7, can be generated using the one or more object detection models, as described herein. For example, a category of an object in the starting image can be recognized and the location of the object can be identified by the one or more object detection models. The foreground image including the object can be segmented from the background of the starting image using the one or more object detection models. A label with the category of the object recognized by the object detection model(s) can be associated with the segmented foreground image of the object. Synthetic images including objects that are labeled with their associated categories can then be generated using the labeled foreground images of the objects in combination with one or more backgrounds.

In some cases, two models can be used to generate synthetic images in the blocks in FIGS. 5, 6A-6C and 7 described above, where a segmentation model (e.g., a deep learning, a vision transformer-based, a Mask R-CNN, an SAM, or a You Only Look Once (YOLO) segmentation model) is used to segment foreground images of objects from a background in a starting image, and a recognition model (e.g., a deep learning, a vision transformer-based, R-CNN, or YOLO model) is used to recognize categories of the objects within the starting image. Coordinates of bounding boxes for the object foregrounds segmented by the segmentation model can be compared to coordinates of bounding boxes for the objects recognized by the recognition model, and bounding boxes that overlap significantly can be associated with one another. The foreground images can be labeled with the categories of the objects therein and subsequently used to generate labeled synthetic training images. For example, an algorithm can be used to determine an intersection over union (IoU) value between bounding boxes identified using the segmentation model and the recognition model, and the IoU value can be used to determine whether to associate two bounding boxes with one another.

In the methods and systems described herein, the object detection models can each contain more than one object detection model. In such cases, an object detection model can include multiple object detection models coupled in series, in parallel, or in a combination of series and parallel. In other words, to perform an object detection model described herein, multiple object detection models can be performed in series or in parallel with one another. When performing models in series, an output of a previous model can be used as an input for, or to determine aspects of, a subsequent model. When performing models in parallel, no output from a model is used as an input for, or to determine aspects of, another model that is being performed in parallel. One or more of: the general object detection model 710, the specialized object detection models 730a, 730b, and the enhanced object detection model 750 of FIG. 7 can contain two or more object detection models that are coupled in series, in parallel, or in a combination of series and parallel. For example, the specialized object detection models 730a, 730b can each include a rule-based model in series with a transformer-based model. In another example, the enhanced object detection model 750 can include two or more deep learning object detection models in series, in parallel, or in a combination of series and parallel.

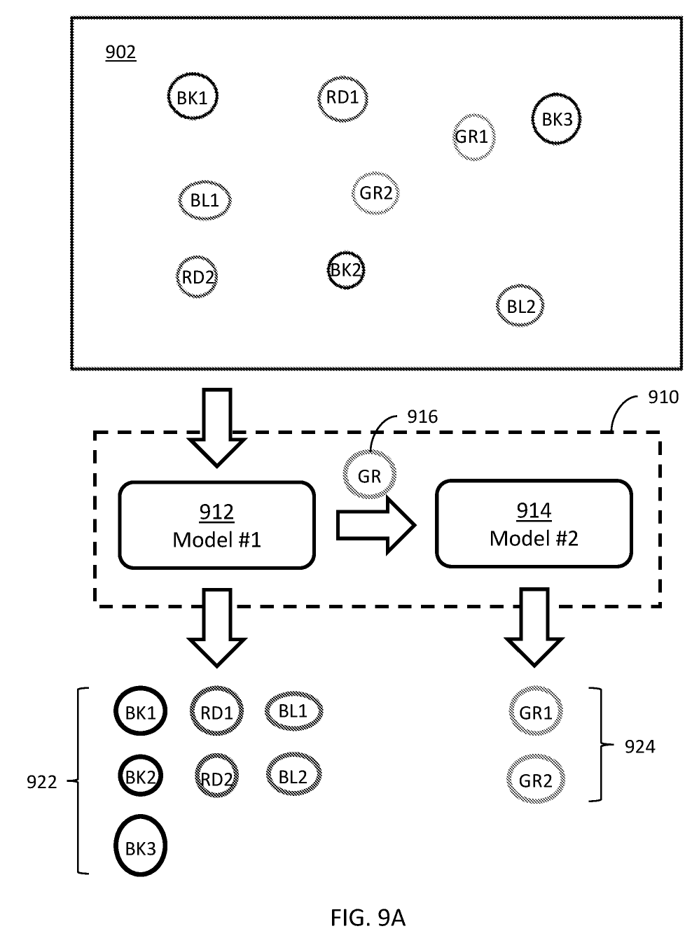

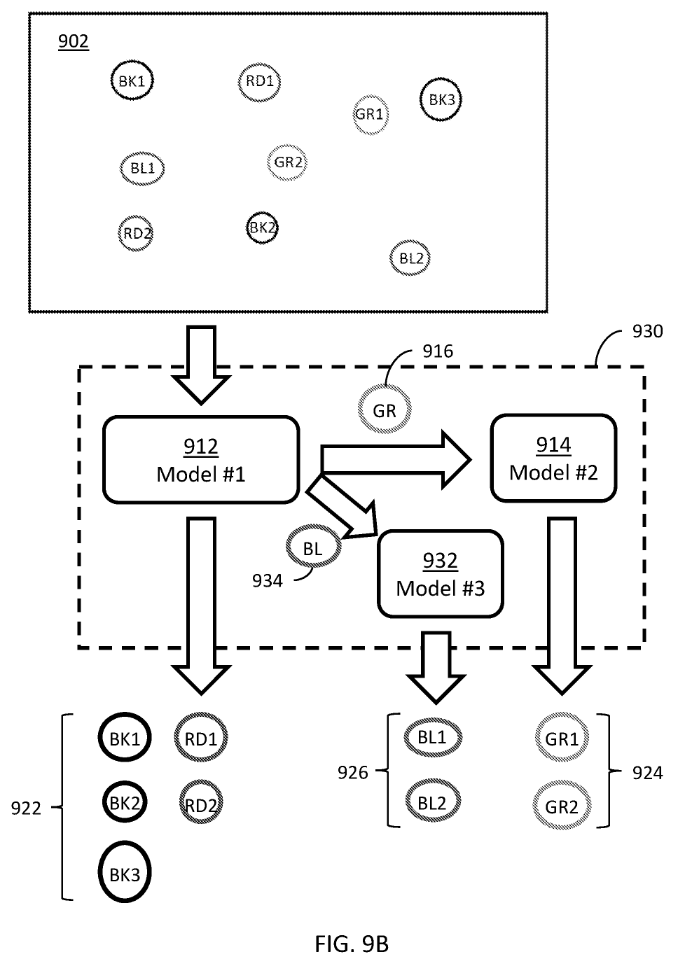

FIG. 9A shows an example flowchart for categorizing objects in an image 902 into sub-categories 922, 924 using an object detection model 910 that includes two object detection models 912, 914 in series. Image 902 includes objects in categories and sub-categories as described with respect to FIGS. 4A and 4B, where the categories are black (“BK”), red (“RD”), blue (“BL”), and green (“GR”), the sub-categories 922 are “BK1,” “BK2,” “BK3,” “RD1,” “RD2,” “BL1,” “BL2,” and the sub-categories 924 are “GR1,” and “GR2.” Object detection model 910 can be, for example, the enhanced object detection model in blocks 2045, 2050, 2055 in FIG. 5, the enhanced object detection model 650, 660 in FIG. 6A, or the enhanced object detection model 750.

The categories and sub-categories 922, 924 of the objects in image 902 can be categorized using the object detection model 910. This can include using object detection model 912 to determine the categories (“BK,” “RD,” “BL” and “GR”), and some of the sub-categories 922. Sub-categories 922 do not include sub-categories for the “GR” category 916, and some or all of the images containing objects in the “GR” category can be identified by object detection model 912 and passed to object detection model 914. Object detection model 914 can then be used to determine the sub-categories 924 of the “GR” category 916. In this way, two object detection models 912, 914 can be used or performed in series to determine the sub-categories 922, 924 in image 902.

FIG. 9B shows an example flowchart for categorizing objects in an image 902 into sub-categories 922, 924, 926 using an object detection model 930. This example is similar to the example shown in FIG. 9A, and additionally, includes a third object detection model 932 that is used to determine sub-categories 926 of the “BL” category 934. In this example, object detection model 930 includes more than two object detection models in a combination series and parallel arrangement since object detection model 912 is in series with object detection models 914, 932, which are in parallel with one another. To perform object detection model 930, object detection model 912 is performed in series with object detection models 914, 932, which are performed in parallel with one another. In other examples, object detection models can be used in series, parallel, or a combination of series and parallel. For example, an object detection model can be used to determine categories of objects, and subsequent models can be used in parallel to determine sub-categories of objects (e.g., as described for the specialized object detection models 730, 730b in FIG. 7).

The object detection models 912, 914, 932 in FIGS. 9A and 9B can be any of the object detection models described herein. For example, object detection models 912, 914, 932 can include one or more of: a deep learning object detection model, a convolutional neural network, a region-based convolutional neural network (R-CNN), a Fast R-CNN, a Faster R-CNN, and a regression-based object detection model. In some cases, the object detection models 912, 914, 932 can include one or more of: vision transformer-based models, agentic object detection models (e.g., VisionAgent from LandingAI), that use reasoning-driven AI, agentic patterns, and intrinsic attribute recognition. In some cases, the object detection models 912, 914, 932 can include one or more rule-based models. In some cases, the object detection models 912, 914, 932 can include combinations of one or more of: rule-based models, deep learning models, and transformer-based models.

The systems shown in FIGS. 9A and 9B can be advantageous as new sub-categories are introduced, since they can enable faster re-training object detection models using fewer resources. In the example in FIG. 9A, object detection model 912 could be a model used for inference to categorize sub-categories 922. Then sub-categories 924 could be introduced into images for categorization. For example, sub-categories 924 could be new defect sub-categories caused by a change in a manufacturing process, or new sub-categories of types of objects due to a change of a supplier. In the example shown in FIG. 9A, object detection model 912 is able to detect category 916, however, it would need to be re-trained to detect sub-categories 924. Performing the two object detection models 912, 914 in series, only the new object detection model 914 would need to be trained on the sub-categories 924, and object detection model 912 can continue to be used as-is, which can save a significant amount of time and resources.

### CLAUSES

Clause 1. A method of object detection using one or more processors, comprising: providing a plurality of images; generating a set of synthetic training images comprising a set of objects by segmenting images of the plurality of images to produce a set of segmented foregrounds representing the set of objects, and combining the set of segmented foregrounds and a set of backgrounds; training a general object detection model to recognize a category of an object in an image using the set of synthetic training images; training a set of specialized object detection models, wherein each specialized object detection model is trained to recognize sub-categories of objects within a category recognizable by the general object detection model using a set of specialized training images, wherein the set of specialized training images comprises less than 10% of the images comprised in the set of synthetic training images; generating, using the set of specialized object detection models, a plurality of refined training images by applying labels that associate an object in each image of the plurality of refined training images with a sub-category of the object; training an enhanced object detection model to recognize the categories and sub-categories of objects in the plurality of images using the generated plurality of refined training images; and determining the categories and sub-categories of objects in a plurality of candidate images using the trained enhanced object detection model.

Clause 2. The method of clause 1, wherein the wherein the general object detection model, or the enhanced object detection model, or both the general object detection model and the enhanced object detection model comprises one or more of a deep learning object detection model, a convolutional neural network, a region-based convolutional neural network (R-CNN), a Fast R-CNN, a Faster R-CNN, or a regression-based object detection model.

Clause 3. The method of clause 1, wherein each specialized object detection model comprises a few-shot learning model, a single-shot detector model, a detection transformer (DETR) model, a you only look once (YOLO) model, a DETR with improved denoising anchor boxes (DINO), a DINOv2 model, a contrastive language-image pre-training (CLIP) model, a Few-CLIP model, a rule-based model, a classification model, or a combination thereof.

Clause 4. The method of clause 1, wherein the segmenting the images is performed using a CNN, an R-CNN, or a Mask R-CNN.

Clause 5. The method of clause 1, wherein the generating the set of synthetic training images further comprises combining the set of segmented foregrounds and the set of backgrounds using an algorithm to vary a position and orientation of the segmented foregrounds, and to combine the segmented foregrounds with a background of the set of backgrounds.

Clause 6. The method of clause 1, wherein the set of synthetic training images comprise background images with different lighting conditions and colors.

Clause 7. The method of clause 1, wherein the set of synthetic training images comprise different positions and orientations of the segmented foregrounds on the set of backgrounds.

Clause 8. The method of clause 1, wherein at least a portion of images in the set of synthetic training images comprise objects that are occluded or partially depicted.

Clause 9. The method of clause 1, wherein each set of specialized training images comprises 10 or fewer specialized training images each comprising an image with objects from a category.

Clause 10. The method of clause 1, wherein the set of synthetic training images comprise images of fish, wherein the category comprises a general type of fish, and wherein the sub-category comprises a specific type of fish or a size.

Clause 11. A system for performing object detection, the system comprising: a general object detection model configured to recognize categories of objects in a plurality of images; a set of specialized object detection models each configured to recognize sub-categories within a category of the objects in the plurality of images, wherein each specialized object detection model corresponds to a category recognized by the general object detection model; an enhanced object detection model configured to recognize categories and sub-categories of the objects in the plurality of images; and one or more processors and memory storing instructions that when executed by the one or more processors cause the one or more processors to perform operations comprising: training the general object detection model to recognize the categories of the objects using a set of training images; training each specialized object detection model of the set of specialized object detection models using a set of specialized training images, wherein the set of specialized training images comprises objects labeled with sub-categories within a category and less than 10% of the images comprised in the set of training images; generating, using the set of specialized object detection models, a plurality of refined training images by applying labels that associate an object in each image of the plurality of refined training images with a sub-category of the object; training an enhanced object detection model to recognize the categories and sub-categories of the objects using the generated plurality of refined training images; and determining the categories and sub-categories of objects in a plurality of candidate images using the trained enhanced object detection model.

Clause 12. The system of clause 13, wherein the general object detection model, or the enhanced object detection model, or both the general object detection model and the enhanced object detection model comprise one or more of: a deep learning object detection model, a convolutional neural network, a region-based convolutional neural network (R-CNN), a Fast R-CNN, a Faster R-CNN, and a regression-based object detection model.

Clause 13. The system of clause 13, wherein each of the specialized object detection models comprises one or more of: a few-shot learning model, a single-shot detector model, a detection transformer (DETR) model, a you only look once (YOLO) model, a DETR with improved denoising anchor boxes (DINO), a DINOv2 model, a contrastive language-image pre-training (CLIP) model, a Few-CLIP model, a rule-based model, a classification model, and a combination thereof.

Clause 14. The system of clause 13, wherein the set of training images comprises a plurality of synthetic images, and wherein the instructions, when executed by the one or more processors, further cause the one or more processors to generate the plurality of synthetic training images by segmenting a plurality of starting images into a set of segmented foregrounds, and combining the set of segmented foregrounds and a set of backgrounds.

Clause 15. The system of clause 16, wherein the segmenting of the plurality of starting images is performed using a CNN, an R-CNN, or a Mask R-CNN.

Clause 16. The system of clause 16, wherein the plurality of synthetic training images comprise background images with different lighting conditions and colors.

Clause 17. The system of clause 16, wherein the plurality of synthetic training images comprise different positions and orientations of the objects.

Clause 18. The system of clause 16, wherein at least a portion of the plurality of synthetic training images comprise objects that are occluded or partially depicted.

Clause 19. The system of clause 16, wherein each set of specialized training images comprises 10 or fewer specialized training images.

Clause 20. The system of clause 13, wherein the set of training images comprise images of fish, wherein the category comprises a general type of fish, and wherein the sub-category comprises a specific type of fish or a size.

Embodiments of the disclosed invention have been referenced in detail, and one or more examples of the disclosed invention have also been illustrated in the accompanying figures. Each of the embodiments and examples herein have been provided to explain the present technology, not as limitations of the present technology. Furthermore, while particular embodiments of the invention have been described in detail, it will be appreciated that alterations to, variations of, and equivalents to these embodiments may be readily conceived of by those skilled in the art, upon attaining an understanding of the foregoing. For instance, features illustrated or described with respect to one embodiment may be used with another embodiment to yield an additional embodiment. It is intended that the present subject matter covers all such modifications and variations within the scope of the appended claims and their equivalents. Those of ordinary skill in the art may practice these and other modifications and variations to the present invention without departing from the scope of the present invention, which is more particularly set forth in the appended claims. Furthermore, the foregoing description is by way of example only, and is not intended to limit the invention, as will be appreciated by those of ordinary skill in the art.

What is claimed is:

1. A method of object detection using one or more processors, comprising:
providing a plurality of images;
generating a set of synthetic training images comprising a set of objects by segmenting images of the plurality of images to produce a set of segmented foregrounds representing the set of objects, and combining the set of segmented foregrounds and a set of backgrounds;
training a general object detection model to recognize a category of an object in an image using the set of synthetic training images;
training a set of specialized object detection models, wherein each specialized object detection model is trained to recognize sub-categories of objects within a category recognizable by the general object detection model using a set of specialized training images, wherein the set of specialized training images comprises less than 10% of the images comprised in the set of synthetic training images;
generating, using the set of specialized object detection models, a plurality of refined training images by applying labels that associate an object in each image of the plurality of refined training images with a sub-category of the object;
training an enhanced object detection model to recognize the categories and sub-categories of objects in the plurality of images using the generated plurality of refined training images; and
determining the categories and sub-categories of objects in a plurality of candidate images using the trained enhanced object detection model.

2. The method of claim 1, wherein the wherein the general object detection model, or the enhanced object detection model, or both the general object detection model and the enhanced object detection model comprises one or more of a deep learning object detection model, a convolutional neural network, a region-based convolutional neural network (R-CNN), a Fast R-CNN, a Faster R-CNN, or a regression-based object detection model.

3. The method of claim 1, wherein each specialized object detection model comprises a few-shot learning model, a single-shot detector model, a detection transformer (DETR) model, a you only look once (YOLO) model, a DETR with improved denoising anchor boxes (DINO), a DINOv2 model, a contrastive language-image pre-training (CLIP) model, a Few-CLIP model, a rule-based model, a classification model, or a combination thereof.

4. The method of claim 1, wherein the segmenting the images is performed using a CNN, an R-CNN, or a Mask R-CNN.

5. The method of claim 1, wherein the generating the set of synthetic training images further comprises combining the set of segmented foregrounds and the set of backgrounds using an algorithm to vary a position and orientation of the segmented foregrounds, and to combine the segmented foregrounds with a background of the set of backgrounds.

6. The method of claim 1, wherein the set of synthetic training images comprise background images with different lighting conditions and colors.

7. The method of claim 1, wherein the set of synthetic training images comprise different positions and orientations of the segmented foregrounds on the set of backgrounds.

8. The method of claim 1, wherein at least a portion of images in the set of synthetic training images comprise objects that are occluded or partially depicted.

9. The method of claim 1, wherein each set of specialized training images comprises 10 or fewer specialized training images each comprising an image with objects from a category.

10. The method of claim 1, wherein the set of synthetic training images comprise images of fish, wherein the category comprises a general type of fish, and wherein the sub-category comprises a specific type of fish or a size.

11. A system for performing object detection, the system comprising:
a general object detection model configured to recognize categories of objects in a plurality of images;
a set of specialized object detection models each configured to recognize sub-categories within a category of the objects in the plurality of images, wherein each specialized object detection model corresponds to a category recognized by the general object detection model;
an enhanced object detection model configured to recognize categories and sub-categories of the objects in the plurality of images; and
one or more processors and memory storing instructions that when executed by the one or more processors cause the one or more processors to perform operations comprising:
training the general object detection model to recognize the categories of the objects using a set of training images;
training each specialized object detection model of the set of specialized object detection models using a set of specialized training images, wherein the set of specialized training images comprises objects labeled with sub-categories within a category and less than 10% of the images comprised in the set of training images;
generating, using the set of specialized object detection models, a plurality of refined training images by applying labels that associate an object in each image of the plurality of refined training images with a sub-category of the object;
training an enhanced object detection model to recognize the categories and sub-categories of the objects using the generated plurality of refined training images; and
determining the categories and sub-categories of objects in a plurality of candidate images using the trained enhanced object detection model.

12. The system of claim 11, wherein the general object detection model, or the enhanced object detection model, or both the general object detection model and the enhanced object detection model comprise one or more of: a deep learning object detection model, a convolutional neural network, a region-based convolutional neural network (R-CNN), a Fast R-CNN, a Faster R-CNN, and a regression-based object detection model.

13. The system of claim 11, wherein each of the specialized object detection models comprises one or more of: a few-shot learning model, a single-shot detector model, a detection transformer (DETR) model, a you only look once (YOLO) model, a DETR with improved denoising anchor boxes (DINO), a DINOv2 model, a contrastive language-image pre-training (CLIP) model, a Few-CLIP model, a rule-based model, a classification model, and a combination thereof.

14. The system of claim 11, wherein the set of training images comprises a plurality of synthetic images, and wherein the instructions, when executed by the one or more processors, further cause the one or more processors to generate the plurality of synthetic training images by segmenting a plurality of starting images into a set of segmented foregrounds, and combining the set of segmented foregrounds and a set of backgrounds.

15. The system of claim 14, wherein the segmenting of the plurality of starting images is performed using a CNN, an R-CNN, or a Mask R-CNN.

16. The system of claim 14, wherein the plurality of synthetic training images comprise background images with different lighting conditions and colors.

17. The system of claim 14, wherein the plurality of synthetic training images comprise different positions and orientations of the objects.

18. The system of claim 14, wherein at least a portion of the plurality of synthetic training images comprise objects that are occluded or partially depicted.

19. The system of claim 14, wherein each set of specialized training images comprises 10 or fewer specialized training images.

20. The system of claim 11, wherein the set of training images comprise images of fish, wherein the category comprises a general type of fish, and wherein the sub-category comprises a specific type of fish or a size.
